(19) United States
(12) Patent Application Publication
(10) Pub. No.: US 2025/0008367 A1
(43) Pub. Date: Jan. 2, 2025

(54) Methods and Apparatus for Enhanced Congestion Marking and Use of Congestion Information In Communications Networks

(71) Applicant: Charter Communications Operating, LLC, St. Louis, MO (US)

(72) Inventors: Yildirim Sahin, Englewood, CO (US); Paul L. Russell, JR., Lawrence, NJ (US); Maulik Vaidya, Escondido, CA (US)

(21) Appl. No.: 18/235,773

(22) Filed: Aug. 18, 2023

Related U.S. Application Data
(60) Provisional application No. 63/524,666, filed on Jul. 1, 2023.

(51) Int. Cl. H04W 28/02

(52) U.S. Cl. CPC H04W 28/0252

(57) ABSTRACT

Data packet congestion marking is supported in devices which may form part of a communications path. The devices which can perform marking can, and in some embodiments do, include non-gNB devices and non-anchor point UPFs, e.g., devices other than gNBs and PSA UPFs such as intermediate UPFs, N3IWFs, TNGFs, and W-AGFs, in addition to gNBs and anchor UPFs. Intermediate UPFs corresponding to a communications session will set the congestion indicator value in a data packet's IP header, of a data packet passing through the UPF, to indicate congestion, if it is not already set to indicate congestion when congestion is detected at the intermediate UPF. A session management function in some embodiments controls which devices perform congestion marking and enables/disables congestion marking, e.g., on a per communications session basis while the session is ongoing and/or at various times during a session establishment or device registration process.

### RELATED APPLICATIONS

The present application claims benefit of U.S. provisional patent application Ser. No. 63/524,666 which was filed Jul. 1, 2023 titled Methods and Apparatus for Enhanced Congestion Marking and Use of Congestion Information In Communications Networks and is hereby expressly incorporated by reference in its entirety.

### FIELD

The present application relates to communications networks and more particularly to methods and/or apparatus for supporting data packet congestion marking and/or using congestion information in communication networks, e.g., to facilitate services requiring low latency.

### BACKGROUND

Congestion marking of data packets corresponding to a communications session based on congestion which occurs at a Next Generation Radio Access Network gNodeB (NG-RAN gNB) can be implemented at a NG-RAN gNB or at a Protocol Data Unit (PDU) Session Anchor User Plane Function (UPF) (i.e., a PSA UPF). While congestion marking may occur at a PSA UPF, such marking is based on congestion detected at the NG-RAN gNB and is not a reflection of congestion which may be occurring at other network nodes including the PSA UPF through which data for the communications session is passed. Thus, in existing systems while a NG-RAN gNB or a PSA UPF may set a congestion indicator of a data packet to indicate congestion, it is congestion at the gNB that determines whether or not the congestion indicator will be set to indicate congestion and congestion at the NG-RAN gNB that is being indicated.

While a congestion indicator can be set at a NG-RAN gNB or PSA UPF in current systems in response to congestion being detected at a NG-RAN gNB, congestion may occur at various other nodes in a communications path. Currently there is no way to provide an indication that the data communicated through a NG-RAN gNB is being subject to congestion when the congestion is occurring at nodes other than the NG-RAN gNB and not at the NG-RAN gNB.

In view of the above, it should be appreciated that there is a need for improving methods and/or apparatus relating to congestion marking/indicating so that devices communicating via a communication session can be informed of congestion and/or take action to mitigate congestion even when the congestion affecting a communications session occurs in a device other than a NG-RAN gNB.

### SUMMARY

In accordance with the invention data packet congestion marking is supported in devices which may form part of a communications path. The devices which can perform marking can, and in some embodiments do, include non-gNB devices and non-anchor point UPFs, e.g., devices other than gNBs and PSA UPFs such as intermediate UPFs, N3IWFs, TNGFs, and W-AGFs, in addition to gNBs and anchor UPFs. PSA UPF is a name often used to refer to the UPF (User Plane Function) which terminates an N6 interface of a PDU session within a 5G core network because it acts as a PDU session anchor.

The devices which can perform the marking of data packets corresponding to a communications session normally include devices which include buffers, sometimes referred to as internal buffer queues, used to buffer packets being communicated as part of the communications session, and/or traffic schedulers used to manage traffic. The devices, which can perform congestion marking, are devices which implement functions and/or provide services to a communications session, e.g., a PDU session. Devices, which can perform congestion marking, may be, and sometime are, implemented in a computing cloud. The devices, which can perform congestion marking can be, but need not be, implemented in a distributed manner, e.g., in a computing cloud, with processing and/or memory corresponding to a device potentially being located at different physical locations. Devices, which can perform congestion marking, may, and sometimes do, operate as functions. For example, a UPF device serves to provide a user plane function to a communications session such as a PDU session.

In accordance with one feature of the invention, devices which can perform congestion marking are permitted to, and do, set the congestion indicator in a data packet corresponding to a communications session to indicate congestion when congestion is detected at the device, e.g., network node, performing the marking. Accordingly, intermediate UPFs corresponding to a communications session will set the congestion indicator value in a data packet's IP header, of a data packet passing through the UPF, to indicate congestion, if it is not already set to indicate congestion when congestion is detected at the UPF. Thus, a packet being communicated as part of a communication session can have the congestion marking of the packet set to indicate congestion as the packet passes through a device in the network which is suffering from congestion when that device is authorized, e.g., enabled, to perform congestion marking for the communications session to which the packet corresponds.

In some embodiments, a PDU Session Anchor UPF (PSA UPF) can, and sometimes does, set a congestion indicator to indicate congestion for data packets of a session when the radio access network node (e.g., gNB) through which the packets are being communicated is not suffering congestion, provided the anchor UPF (i.e., PSA UPF) itself is suffering from congestion. Accordingly, unlike the prior art approach, even when the gNB being used in a communications session is not suffering from congestion, the anchor UPF (i.e., PSA UPF) will set the congestion indicator for data packets corresponding to a communications session it is handling when it detects congestion occurring at the anchor UPF (i.e., PSA UPF), and the congestion indicator is not already set to indicate congestion.

In some embodiments, a congestion indicator is used to indicate that congestion has been detected by at least one device along the communications path. For example, consider a communications path which includes multiple nodes which are enabled for congestion detection at the node and congestion marking at the node, e.g., a communications path including a gNB, one or more UPFs, and a PSA UPF. If any of the enabled congestion detection and congestion marking devices along the communication path detects congestion, an end node (e.g., a UE or an application server) of communication path for the communications session will receive an indication of congestion.

In various embodiments a session management function (SMF) is used to control which devices supporting a communications session are to perform congestion marking. Devices which are not enabled to perform congestion marking pass the congestion marking information they receive with a data packet unchanged. Enabling for congestion marking can be, and sometimes is, on a per communications session, e.g., PDU session, basis with a device being enabled to perform marking for some communications being supported by the device but not others. The congestion marking can be, and sometimes is, enabled/disabled at a device for a communication session while the session is ongoing and/or at various times during a session establishment or device registration process.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary communications system in accordance with an exemplary embodiment.

FIG. 2 includes drawings illustrating congestion in downlink and congestion in uplink.

FIG. 3 is a drawing illustrating an exemplary user plane function (UPF) performing ECN marking in received uplink packets due to congestion detected in the UPF uplink.

FIG. 4 is a drawing illustrating an exemplary UPF performing ECN marking in received downlink packets due to congestion detected in the UPF downlink.

FIG. 5 illustrates how ECN traversal is handled throughout a network.

FIG. 6 is a drawing illustrating uplink (UL) traffic congestion in the NG-RAN (i.e., gNB) and UL traffic congestion in an intermediate UPF node.

FIG. 7 is a drawing illustrating downlink (DL) traffic congestion in the NG-RAN (i.e., gNB) and DL traffic congestion in an intermediate UPF node.

FIG. 8A is a first part of a signaling diagram illustrating an example of how ECN marking may be handled when congestion is experienced in both the NG-RAN and UPF, in accordance with an exemplary embodiment.

FIG. 8B is a second part of a signaling diagram illustrating an example of how ECN marking may be handled when congestion is experienced in both the NG-RAN and UPF, in accordance with an exemplary embodiment.

FIG. 8 comprises the combination of FIG. 8A and FIG. 8B.

FIG. 9 is a drawing of an exemplary user equipment (UE) in accordance with an exemplary embodiment.

FIG. 10 is a drawing of an exemplary core network node, e.g., an AMF device, a SMF device, a UPF device, a PSA UPF device, in accordance with an exemplary embodiment.

FIG. 11 is a drawing of an exemplary base station, e.g., a gNB, in accordance with an exemplary embodiment.

FIG. 12 is a drawing of an exemplary core network interface device, e.g., a W-AGF, N3IWF, or a TNGF.

FIG. 13 is a flowchart of an exemplary method of operating a network node, e.g., a user plane function (UPF) device, in accordance with an exemplary embodiment.

FIG. 14A is a first part of a flowchart of an exemplary method of operating a session management function (SMF) device in accordance with an exemplary embodiment.

FIG. 14B is a second part of a flowchart of an exemplary method of operating a session management function (SMF) device in accordance with an exemplary embodiment.

FIG. 14 comprises the combination of FIG. 14A and FIG. 14B.

### DETAILED DESCRIPTION

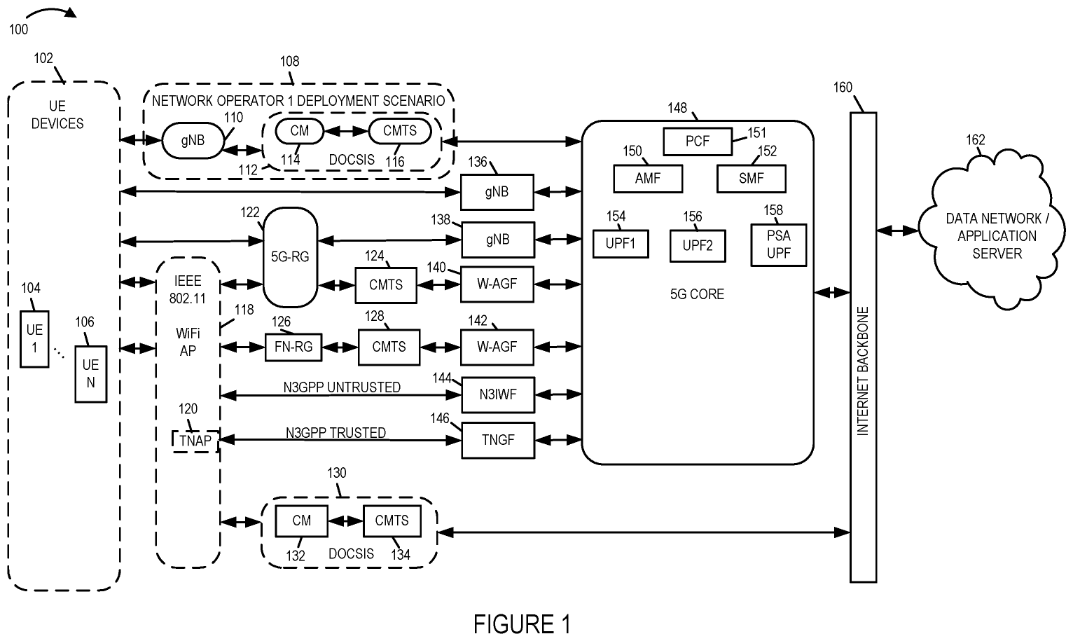

FIG. 1 is a drawing of an exemplary communications system 100 in accordance with an exemplary embodiment. Exemplary communication system 100 includes UE devices (UEs) 102, a gNB 110, a Data Over Cable Service Interface Specification (DOCSIS) network 112, a gNB 136, a 5G Residential Gateway (5G-RG) 122, a gNB 138, a IEEE 802.11 WiFi access point (AP) 118, a Cable Modem Termination System (CMTS) 124, a Wireline Access Gateway Function (W-AFG) 140, a Fixed Network Residential Gateway (FN-RG 126), a CMTS 128, a W-AGF 142, a non-3GPP interworking function (N3IWF) 144, a Trusted Non-3GPP Gateway Function (TNGF) 146, 5G core network 148, a DOCSIS network 130, a Internet backbone 160 and a data network/application server 162, coupled together as shown.

UE devices 102 includes a plurality of UEs (UE1 104, . . . , UEN 106). The UEs (104, . . . , 106) may, and sometimes do include applications which require L4S. The gNB 110 and DOCSIS network 112 are part of a network operator 1 deployment scenario. The DOCSIS network 112 includes a Cable Modem (CM) 114 and a CMTS 116 coupled together. WiFi AP 118 includes a Trusted Non-3GPP Access Point (TNAP) 120 which is coupled to TNGF 146. DOCSIS 130 includes CM 132 and CMTS 134 coupled together. 5G core 148 includes access and mobility management function (AMF) 150, session management function (SMF) 152 and a plurality of user plane function (UPFs) including UPF1 154, UPF2 156 and Protocol Data Unit (PDU) Session Anchor (PSA) UPF 158.

Exemplary system 100 supports Low Latency, Low Loss and Scalable Throughput services (L4S). In system 100 Explicit Congestion Notification (ECN) marking is used for the purpose of L4S when congestion is detected in the uplink path and downlink path so that the application layer can trigger real-time and gradual rate adaptation of the real-time video encoder based on ECN feedback.

In accordance with a feature of the present invention, UPFs including intermediate UPFs and PSA UPFs can be enabled to, and sometimes do, detect for congestion, at the UPF, and perform ECN markings, in addition to gNBs. In some embodiments, of the present invention additional devices, e.g., additional devices including data buffers (queues) and/or traffic schedulers, can be, and sometimes are enabled to, and sometimes do detect for congestion, and perform ECN markings. Such additional devices include, e.g., a N3IWF 144, TNGF 146, and W-AGFs 140, 142.

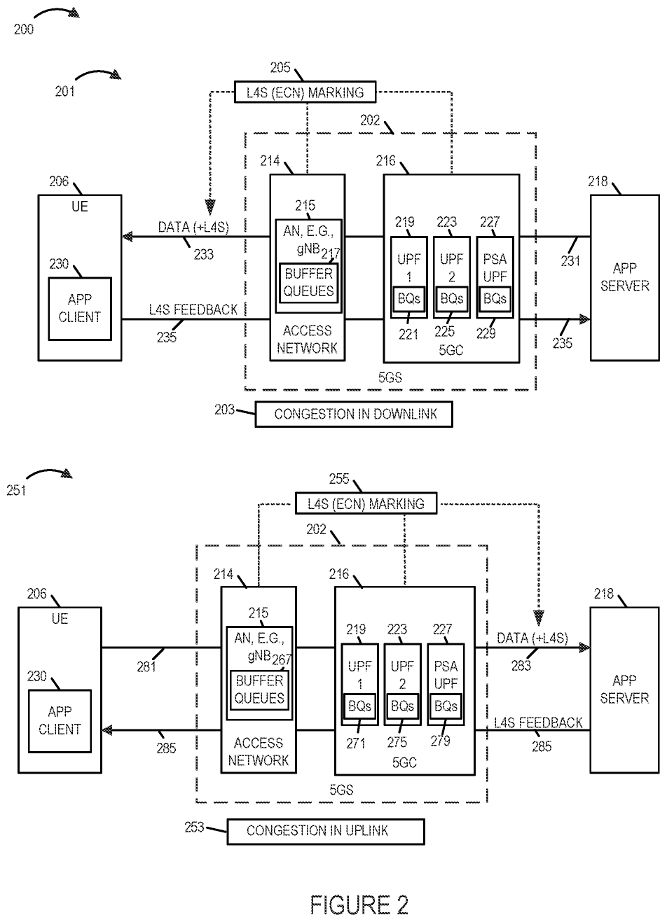

FIG. 2 is a drawing illustrating an exemplary 5G system in accordance with an exemplary embodiment, in which the system uses ECN marking for the purpose of Low Latency, Low Loss Scalable Throughput Services (L4S) when congestion is detected in the uplink or downlink so that the application layer can trigger real-time adaption of real time traffic (i.e., video encoder) based on ECN feedback, and in which both gNB devices and UPF devices can be, and sometimes are, enabled, e.g. on an individual device basis, to monitor for congestion and perform ECN marking for congestion.

Drawing 200 of FIG. 2 includes illustrations (201, 251) where the 5G System 202 uses ECN marking (205, 255) for the purpose of Low Latency, Low Loss and Scalable Throughput services (L4S) when congestion is detected in the uplink or downlink so that the application layer can trigger real-time and gradual rate adaptation of the real-time traffic (i.e., video encoder) based on ECN feedback.

FIG. 2 is a drawing 200 including a first drawing 201 illustrating congestion in downlink as indicated by label 203, and a second drawing 251 illustrating congestion in uplink, as indicated by label 253. In drawing 200 the exemplary communications system includes 5GS 202 including access network (AN) 214, e.g., a gNB, including buffer queues 217 (e.g., for downlink data packets). The exemplary communications system further includes 5GC 216 including a plurality of UPFs (UPF 1 219, UFP2 223, and PSA UPF 227), each including one or more buffer queues (BQs), e.g., for downlink data packets, (221, 225, 229), respectively. The system further includes UE 206 including application client 230, and application server 218. A PDU communications session can be, and sometimes is, established between UE 206 (application client 230 of UE 206 which requires L4S), and application server 218. In one exemplary embodiment, UE 206 is UE 1 104 of FIG. 1, AN 215, e.g., a gNB, is gNB 136 of FIG. 1, 5GC 216 is 5GC 148 of FIG. 1, and application server 218 is included in data network/application server 162 of FIG. 1.

In the example of drawing 201, consider that PSA UPF 227, UPF2 223, UPF1 219 and gNB 215 are enabled to monitor for congestion and perform ECN markings with regard to a downlink path direction for a PDU communications session between UE 206 and application server 218. Signals 231 include, e.g., a data packet with IP header ECN field value set to a value indicating ECT(1). Each of PSA UPF 227, UPF2 223, UPF 1 219, and gNB 215, along the downlink data path monitors for congestion, e.g., based on the status of its buffers (229, 225, 221, 217), respectively, and if congestion is detected, and congestion is not already indicated, then the device marks (205) the data packet, e.g., ECN field of IP header, to indicate congestion, e.g., setting the ECN value to a value indicating CE. The output signal 233 from AN, e.g., gNB, 215 to UE 206 includes data+L4S congestion information. If any one of devices 227, 223, 219 or 215, detected congestion, then the signal 233 indicates congestion, e.g., with ECN value set to a value indication CE. In response, UE 206 communicates, e.g., sends, L4S feedback signals 235, via 5GS 202, to application server 218.

In drawing 251 the exemplary communications system includes 5GS 202 including access network (AN) 214, e.g., a gNB, including buffer queues 267 (e.g., for uplink data packets). The exemplary communications system further includes 5GC 216 including a plurality of UPFs (UPF 1 219, UFP 2 223, and PSA UPF 227), each including one or more buffer queues (BQs), e.g., for uplink data packets, (271, 275, 279), respectively. The system further includes UE 206 including application client 230, and application server 218. A PDU communications session can be, and sometimes is, established between UE 206 (application client 230 of UE 206 which requires L4S), and application server 218. In one exemplary embodiment, UE 206 is UE 1 104 of FIG. 1, AN 215, e.g., a gNB, is gNB 136 of FIG. 1, 5GC 216 is 5GC 148 of FIG. 1, and application server 218 is included in data network/application server 162 of FIG. 1.

In the example of drawing 251, consider that gNB 215, UPF1 219 UPF2 223, PSA UPF 227 are enabled to monitor for congestion and perform ECN markings, with regard to an uplink path direction for a PDU communications session between UE 206 and application server 218. Signals 281 include, e.g., a data packet with IP header ECN field value set to a value indicating ECT(1). Each of gNB 215, UPF 1 219, UPF 2 223, and PSA UPF 227, along the uplink data path monitors for congestion, e.g., based on the status of its buffers (267, 271, 275, 279), respectively, and if congestion is detected, and congestion is not already indicated, then the device marks (255) the data packet, e.g., ECN field of IP header, to indicate congestion, e.g., setting the ECN value to a value indicating CE. The output signal 283 from PSA UPF 227 to application server 218 includes data+L4S congestion information. If any one of devices 215, 219, 223 or 227, detected congestion, then the signal 283 indicates congestion, e.g., with ECN value set to a value indication CE. In response, application server 218 communicates, e.g., sends, L4S feedback signals 285, via 5GS 202, to UE 206.

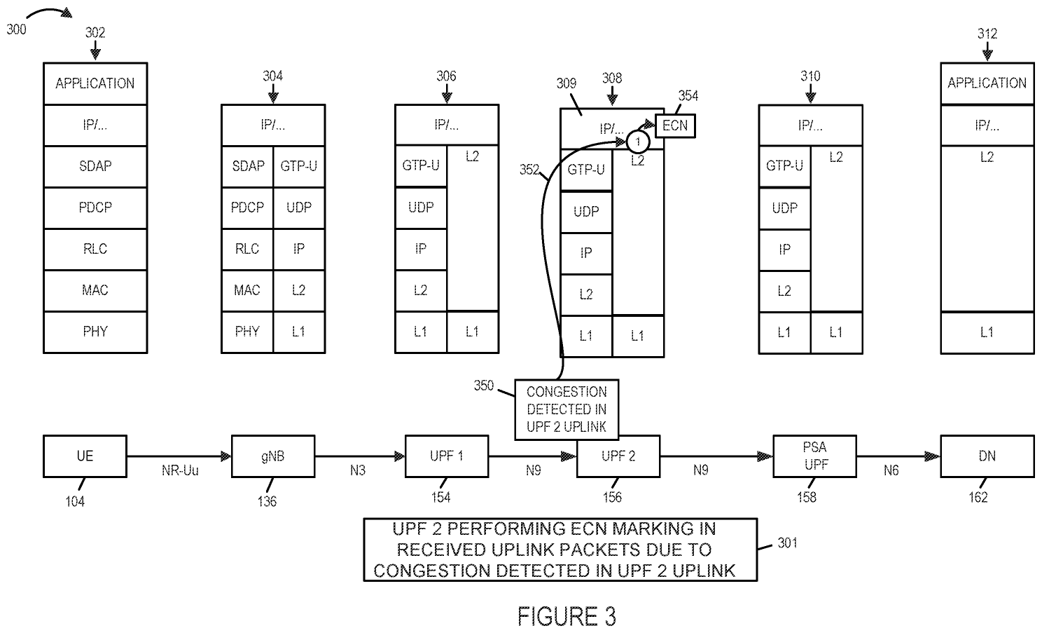

FIG. 3 is a drawing 300 illustrating UPF 2 156 performing ECN marking in received uplink packets due to congestion detected in UPF 2 uplink, as indicated by label 301. Drawing 300 illustrates an exemplary uplink direction communications data path between UE 104 and data network (DN) 162 (UE 104->gNB 136->UPF 1 154->UPF 2 156->PSA UPF 158->DN 162, via interfaces (NR-Uu, N3, N9, N9, N6), respectively). Blocks (302, 304, 306, 308, 310, 312) illustrate protocol stack at each of (UE 104, gNB 136, UPF 1 154, UPF 2 156, PSA UPF 158, DN 162), respectively.

Consider that each of devices (136, 154, 156, 158) has been enabled, e.g., via a SMF, to: i) monitor for congestion in the uplink direction at its node, e.g., based on its buffers, and ii) perform ECN congestion marking in the uplink direction at its node. In this example, consider that UPF 2 156, is the first device along the uplink communications data path, which has detected congestion, as indicated by box 350. UPF 2 156 performs an ECN marking, e.g., changing (352) the ECN (354) value in the IP header 309, which was indicating ECT(1) to a value indicating CE signifying congestion.

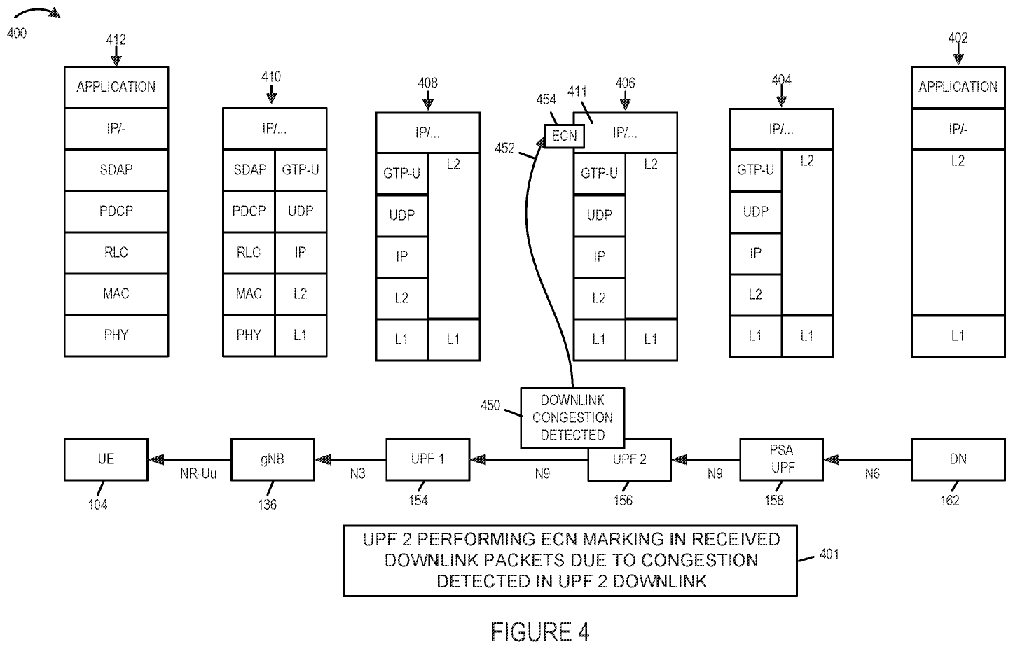

FIG. 4 is a drawing 400 illustrating UPF 2 156 performing ECN marking in received downlink packets due to congestion detected in UPF 2 downlink, as indicated by label 401. Drawing 400 illustrates an exemplary downlink direction communications data path between data network (DN) 162 and UE 104 (DN 162->PSA UPF 158->UPF 2 156->UPF 1 154->gNB 136->UE 104, via interfaces (N6, N9, N9, N3, NR-Uu), respectively). Blocks (402, 404, 406, 408, 410, 412) illustrate protocol stack at each of (DN 106, PSA UPF 158, UPF 2 156, UPF 1 154, gNB 136, UE 104), respectively.

Consider that each of devices (158, 156, 154, 136) has been enabled, e.g., via a SMF, to: i) monitor for congestion in the downlink direction at its node, e.g., based on its buffers, and ii) perform ECN congestion marking in the downlink direction at its node. In this example, consider that UPF 2 156, is the first device along the downlink communications data path, which has detected congestion, as indicated by box 450. UPF 2 156 performs an ECN marking, e.g., changing (452) the ECN (454) value in the IP header 411, which was indicating ECT(1) to a value indicating CE signifying congestion.

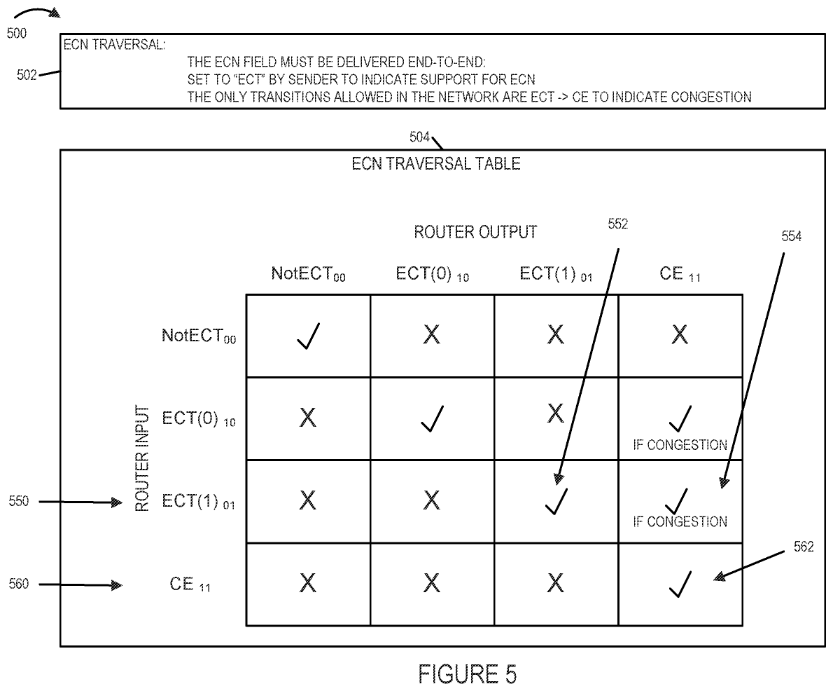

Drawing 500 of FIG. 5 illustrates how ECN traversal is handled throughout a network. Note that the input IP Header ECN field only allows a transition from ECT to CE for proper processing throughout the network. FIG. 5 is a drawing 500 including information 502 explaining ECN traversal and an ECN traversal table 504. ECN traversal information 502 indicates that the ECN field must be delivered end-to-end. The value of ECN in the ECN field is set to “ECT” by the sender to indicate support for ECN. The only transitions allowed in the network are ECT->CE to indicate congestion. ECN traversal table 504 plots router input vs router output.

In the examples, of FIGS. 2, 3, and 4, the ECN field is set to ECT, e.g., ECT(1), by the sender, e.g., a UE for uplink direction, or an application server of a data network for downlink direction. If a device along the data communications path, which is enabled for ECN marking, receives an input ECT(1) 550, then there are two possible outputs. If the device is not congested, then the device outputs ECT(1) 552; however, if the device is congested then the device outputs CE 554.

If a device along the data communications path, which is enabled for ECN marking, receives an input CE 560, then there is only one possible output, which is CE 562.

In one embodiment, NotECT maps to bit pattern 00, ECT(0) maps to bit pattern 10, ECT(1) maps to bit pattern 01, and CE maps to bit pattern 11.

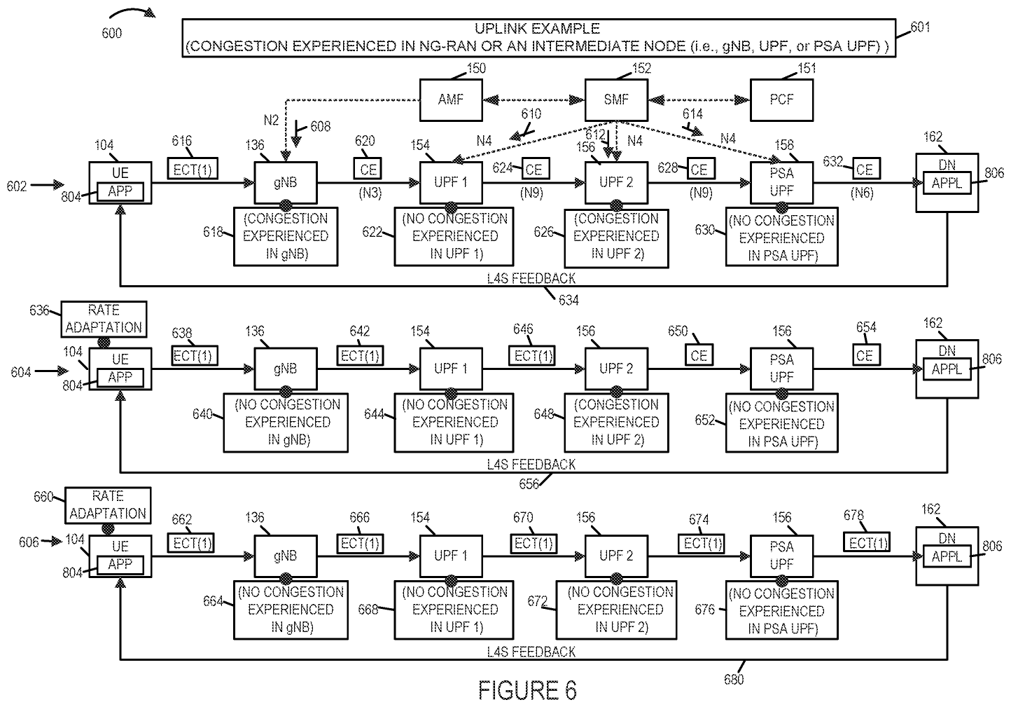

FIG. 6 is a drawing 600 illustrating UL traffic congestion in the NG-RAN (i.e., gNB) and UL traffic congestion in an intermediate UPF node. Information block 601 indicates that FIG. 6 is an uplink example in which congestion may be experienced in NG-RAN or an intermediate node (i.e., gNB, UPF, or PSA UPF), and the NG-RAN and intermediate nodes (i.e., gNB 136, UPF 1 154, UPF 2 156, and PSA UPF 158), have each been enabled to monitor for congestion and perform ECN marking.

Drawing 600 depicts the following:
1) ECN field of the PDU's IP header is set by the UE's application to ECT(1) (which indicates a request for L4S treatment of the PDU).
2) ECN field is set to CE by the gNB (which indicates congestion experienced in the NG-RAN) and the traversal of the ECN throughout the 3PP network.
3) ECN filed is set to CE by an intermediate node (i.e., UPF) indicating congestion experienced within its internal queue and traversal of the ECN throughout the 3GPP network.
4) Resolution of the congestion via L4S feedback (by the receiving application) and rate adaptation of the sending application.
5) SMF may enable the gNB and/or the UPF to indicated congestion independently via the 3GPP reference points N2 and N4 during Registration and/or during PDU Session procedures.

Note: Enabling “node congestion reaction” behavior (i.e. dual-AQM, ECN field marking=CE, etc.) is a dynamic capability which allows:
i) enabling/disabling “node congestion reaction” on a per UE basis;
ii) enabling/disabling “node congestion reaction” in a per UE per PDU basis;
iii) enabling/disabling “node congestion reaction” on a per direction (UL or DL) basis;
iv) enabling/disabling “node congestion reaction” on a nodal basis (e.g., gNB, UPF, n3iWF/TNGF, W-AGF, etc.); and/or
v) any combination thereof.

Portion 602 of drawing 600 illustrates nodes (gNB 136, UPF1 154, UPF2 156, and PSA UPF 158) receiving signals (608, 610, 612, 614), respectively, sourced from SMF 152, which enables the nodes (gNB 136, UPF1 154, UPF 2 156, and PSA UPF 158) to perform congestion monitoring and ECN congesting marking, e.g., for uplink data packets for a PDU session between an application 804 on UE 104 and application server 806 in DN 162. Portion 602 further illustrates uplink data path signaling between UE 104 and DN 162. The application on UE sends the ECN field of the PDU's IP header set by the UE's application to ECT(1) 616 (which indicates a request for L4S treatment of the PDU). In step 618 gNB 136 determines that the gNB is experiencing congestion in the uplink direction. The ECN field is set to CE by the gNB (which indicates congestion experienced in the NG-RAN) and forwarded (620, 624, 628, 632) to the application server in the DN 162. Since the ECN has been set to CE by the gNB 136, the ECN value will remain at CE, irrespective of the congestion conditions detected by the UPFs (154, 156, 158) in steps (622, 626, 630). The application server of the DN 162 receives the CE indication, generates L4S feedback 634 and sends the L4S feedback information to the application of UE 104, which receives the L4S feedback information.

In portion 604 of drawing 600 the UE, in step 636, performs a rate adaptation based on the feedback information 634. The application on UE 104 sends the ECN field of the PDU's IP header set by the UE's application to ECT(1) 638 (which indicates a request for L4S treatment of the PDU). In step 640 gNB 136 determines that the gNB is not experiencing congestion in the uplink direction. The ECN field is not modified and ECT(1) 642 is conveyed to UPF 1 154. In step 644 UPF1 154 determines that the UPF1 154 is not experiencing congestion in the uplink direction. The ECN field is not modified and ECT(1) 646 is conveyed to UPF 2 156. UPF2 156 determines in step 648 that congestion is being experienced in UPF 2 156 in the uplink direction. The ECN field is set to CE 650 by an intermediate node UPF 2 156 indicating congestion experienced within its internal queue and forwarded (654) to the application server in the DN 162. Since the ECN has been set to CE by UPF 2 156, the ECN value will remain at CE, irrespective of the congestion conditions detected by the PSA UPF 158 in steps 652. The application server of the DN 162 receives the CE indication, generates L4S feedback 656 and sends the L4S feedback information to the application of UE 104, which receives the L4S feedback information.

In portion 606 of drawing 600 the UE, in step 660, performs a rate adaptation based on the feedback information 656. The application on UE 104 sends the ECN field of the PDU's IP header set by the UE's application to ECT(1) 662 (which indicates a request for L4S treatment of the PDU). In step 664 gNB 136 determines that the gNB is not experiencing congestion in the uplink direction. The ECN field is not modified and ECT(1) 666 is conveyed to UPF 1 154. In step 668 UPF1 154 determines that the UPF1 154 is not experiencing congestion in the uplink direction. The ECN field is not modified and ECT(1) 670 is conveyed to UPF 2 156. In step 672 UPF2 156 determines that the UPF2 156 is not experiencing congestion in the uplink direction. The ECN field is not modified and ECT(1) 674 is conveyed to PSA UPF 158. In step 676 PSA UPF 158 determines that the PSA UPF 158 is not experiencing congestion in the uplink direction. The ECN field is not modified and ECT(1) 678 is conveyed to the application server of DN 162. The application server of the DN 162 receives the ECT(1) indication, generates L4S feedback 680 and sends the L4S feedback information to the application of UE 104, which receives the L4S feedback information, and determines that further rate adaptation is not needed at this time.

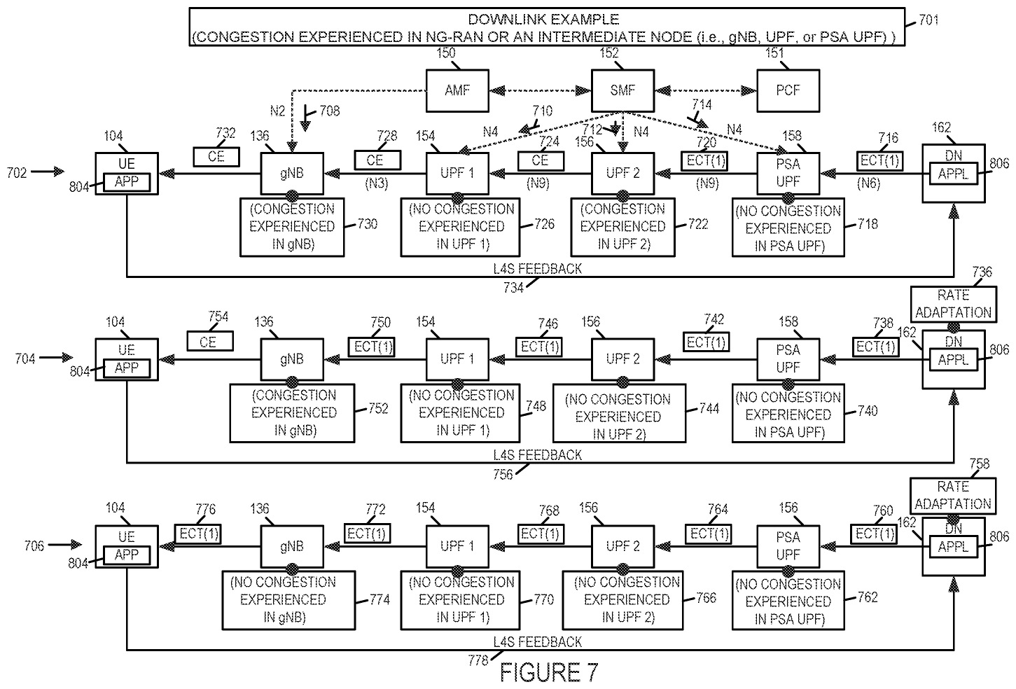

FIG. 7 is a drawing 700 illustrating DL traffic congestion in the NG-RAN (i.e., gNB) and DL traffic congestion in an intermediate UPF node. Information block 701 indicates that FIG. 7 is a downlink example in which congestion may be experienced in NG-RAN or an intermediate node (i.e., gNB, UPF, or PSA UPF), and the NG-RAN and intermediate nodes (i.e., gNB 136, UPF 1 154, UPF 2 156, and PSA UPF 158), have each been enabled to monitor for congestion and perform ECN marking.

Drawing 700 depicts the following:
1) ECN field of the PDU's IP header is set by the DN's application to ECT(1) (which indicates a request for L4S treatment of the PDU).
2) ECN field is set to CE by an intermediate node (i.e., UPF) indicating congestion experienced within its internal queue and traversal of the ECN throughout the 3GPP network.
3) ECN field is set to CE by the gNB (which indicates congestion experienced in the NG-RAN) and the communication of the ECN to the application on the UE.
4) Resolution of the congestion via L4S feedback (by the receiving application) and rate adaptation of the sending application.
5) SMF may enable the gNB and/or the UPF to indicate congestion independently via the 3GPP reference points N2 and N4 during Registration and/or during PDU Session procedures.

Portion 702 of drawing 700 illustrates nodes (gNB 136, UPF1 154, UPF2 156, and PSA UPF 158) receiving signals (708, 710, 712, 714), respectively, sourced from SMF 152, which enables the nodes (gNB 136, UPF1 154, UPF 2 156, and PSA UPF 158) to perform congestion monitoring and ECN congesting marking, e.g., for downlink data packets for a PDU session between an application server 806 in DN 162 and an application 804 on UE 104. Portion 702 further illustrates downlink data path signaling between DN 162 and UE 104. The application server in DN 162 sends the ECN field of the PDU's IP header set by the DN's application to ECT(1) 716 (which indicates a request for L4S treatment of the PDU). In step 718 PSA UPF 158 determines that the PSA UPF 158 is not experiencing congestion in the downlink direction. The ECN field is not modified and ECT(1) 720 is conveyed to UPF 2 156. UPF2 156 determines in step 722 that congestion is being experienced in UPF 2 156 in the downlink direction. The ECN field is set to CE by intermediate node UPF 2 156 indicating congestion experienced within its internal queue and the ECN field indicating CE (724) is sent to the UPF 1 154. Since the ECN has been set to CE by UPF 2 156, the ECN value will remain at CE, irrespective of the congestion conditions detected by other devices (UPF 1 154 and gNB 136) along the downlink path to UE 104. In step 726 UPF 1 154 determines that UPF 1 154 is not experiencing congestion in the downlink direction. In step 728 UPF 1 154 forwards CE to gNB 136. In step 730 gNB 136 determines that gNB 136 is experiencing congestion in the downlink direction. In step 732 gNB 136 forwards CE to UE 104. The application of UE 104 receives the CE indication, generates L4S feedback 734 and sends the L4S feedback information to the application server of DN 162, which receives the L4S feedback information.

In portion 704 of drawing 700 the application server of DN 162, in step 736, performs a rate adaptation based on the feedback information 734. The application server on DN 162 sends the ECN field of the PDU's IP header set by the application server's application to ECT(1) 738 (which indicates a request for L4S treatment of the PDU). In step 740 PSA UPF 158 determines that the PSA UPF is not experiencing congestion in the downlink direction. The ECN field is not modified and ECT(1) 742 is conveyed to UPF 2 156. In step 744 UPF2 156 determines that the UPF2 156 is not experiencing congestion in the downlink direction. The ECN field is not modified and ECT(1) 746 is conveyed to UPF 1 154. UPF1 154 determines in step 748 that congestion is not being experienced in UPF 1 154 in the downlink direction. The ECN field is not modified and ECT(1) 750 is conveyed to gNB 136. In step 752 gNB 136 determines that gNB 136 is experiencing congestion in the downlink direction. The ECN field is set to CE by gNB 136 indicating gNB 136 congestion experienced within its internal queue and the ECN field indicating CE (732) is sent to UE 104. The application of UE 104 receives the CE indication, generates L4S feedback 756 and sends the L4S feedback information to the application server of DN 162, which receives the L4S feedback information.

In portion 706 of drawing 700 the application server of DN 162, in step 758, performs a rate adaptation based on the feedback information 756. The application server on DN 162 sends the ECN field of the PDU's IP header set by the application server's application to ECT(1) 760 (which indicates a request for L4S treatment of the PDU). In step 762 PSA UPF 158 determines that the PSA UPF is not experiencing congestion in the downlink direction. The ECN field is not modified and ECT(1) 764 is conveyed to UPF 2 156. In step 766 UPF2 156 determines that the UPF2 156 is not experiencing congestion in the downlink direction. The ECN field is not modified and ECT(1) 768 is conveyed to UPF 1 154. UPF1 154 determines in step 770 that congestion is not being experienced in UPF 1 154 in the downlink direction. The ECN field is not modified and ECT(1) 772 is conveyed to gNB 136. gNB 136 determines in step 774 that congestion is not being experienced in the gNB in the downlink direction. The ECN field is not modified and ECT(1) 776 is conveyed to UE 104. The application of UE 104 receives the ECT(1) indication, generates L4S feedback 778 and sends the L4S feedback information to the application of the application server in DN 162, which receives the L4S feedback information, and determines that further rate adaptation is not needed at this time.

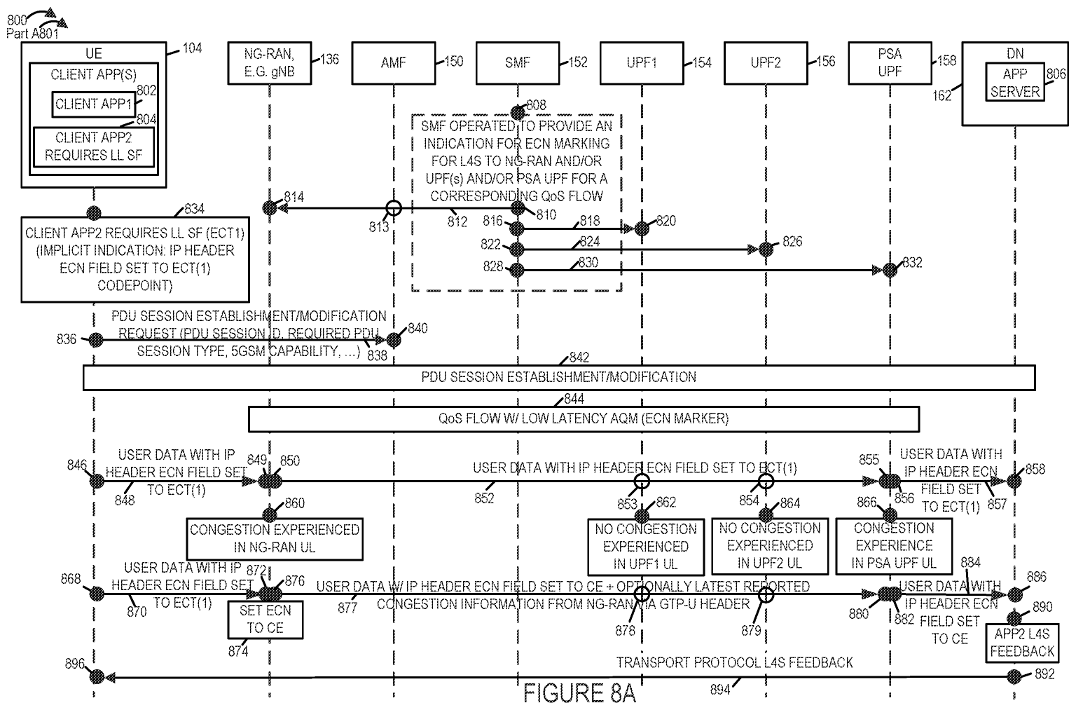

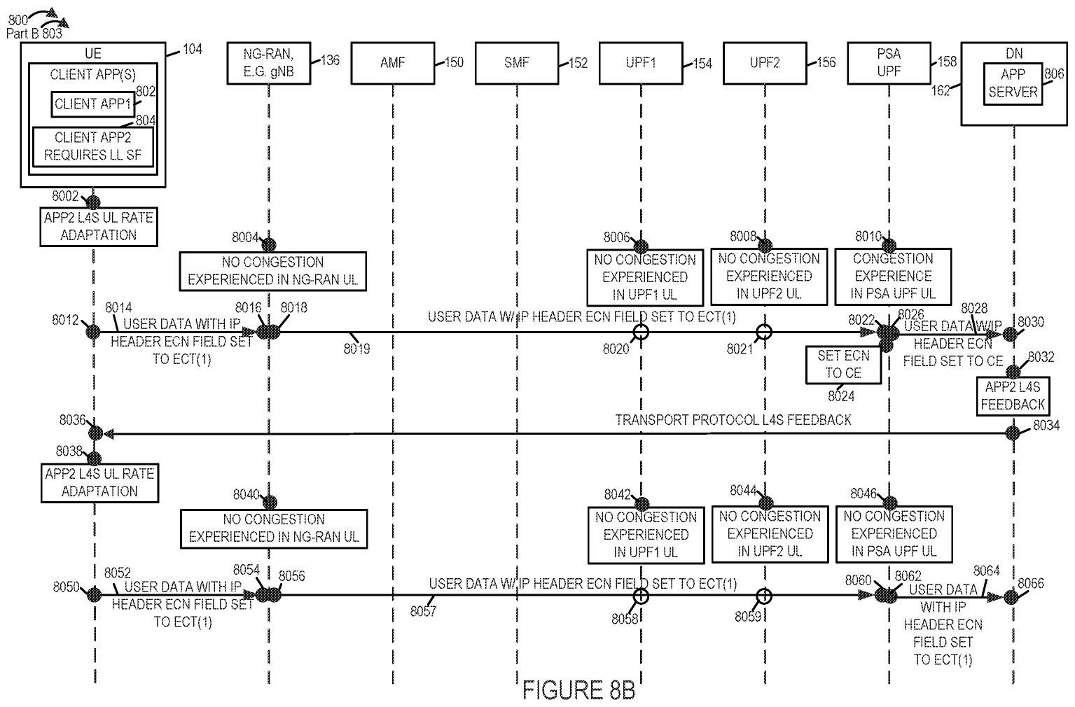

FIG. 8 comprising the combination of FIG. 8A and FIG. 8B, is a signaling diagram 800, comprising the combination of Part A 801 and Part B 803, illustrating an example of how ECN marking may be handled when congestion is experienced in both the NG-RAN and UPF. Also, at a high level diagram 800 illustrates that the SMF may be, and sometimes is, configured to provide an indication for ECN marking for L4S to the NG-RAN and the UPF, e.g. the SMF sends control signal to the NG-RAN and/or UPF(s) to enable ECN congestion monitoring and ECN marking.

The SMF may be configured to, based on Policy and Charging Control rule (PCC rule), provide an indication for ECN marking for L4S to NG-RAN and/or UPF(s) for a corresponding QoS flow(s), but in the absence of such configuration the use of L4S on a QoS flow is controlled by a coordinated configuration in NG-RAN and 5GC.

The configuration signaling to enable congestion monitoring and congestion marking, e.g., at one or more of: gNB, UPF(s) and PSA UPF may be, and sometimes is, performed during registration, Session Establishment, and/or Session Modification.

In some embodiments, ECN marking for the L4S in the IP header is supported in the NG-RAN, in the PSA UPF, and/or in the UPF. In some embodiments, whether NG-RAN, UPF, or PSA UPF based ECN marking for L4S is used is decided by SMF based on operator's network configuration and policies.

In the case of ECN marking for L4S by UPF, the UPF is instructed to perform congestion information monitoring. In some embodiments in the case of ECN marking for L4S by PSA UPF, the PSA UPF is instructed to perform congestion information monitoring.

In some embodiments, to enable ECN marking for L4S by a UPF, a QoS Flow level ECN marking for L4S indicator may be sent by SMF to UPF(s) over N4. SMF also indicates to UPF(s) to report the congestion information (i.e., a percentage of packets that it uses for ECN marking for L4S) of the QoS flow on UL and/or DL directions via GTP-U header extension to PSA UPF. If there is no UL packet when report for DL and/or UL needs to be provided, UPF(s) may generate an UL Dummy GTP-U Packet for such reporting. GTP stands for GPRS Tunnelling Protocol. GTP is a group of IP-based communications protocols. GTP-U is a GTP protocol that is often used for carrying user data within a core network and between the radio access network and the core network

Upon successful activation of congestion information reporting for UL and/or DL, PSA UPF uses information sent by UPF(s) in GTP-U header extension to perform ECN bits marking for L4S for the corresponding direction. In some embodiments the PSA UPF uses the information sent in the GTP-U header to perform the ECN marking and to support congestion information exposure. This involves, in some embodiments the PSA UPF exposing the UL and/or DL congestion information via a Nupf_EventExposure service or via SMF/PCF/NEF in a manner which is the same as or similar to the manner described in publicly available 3GPP TS 23.501 V18.2.1 (2023-06) 3rd Generation Partnership Project; Technical Specification Group Services and System Aspects; System architecture for the 5G System (5GS); Stage 2 (Release 18) which is hereby expressly incorporated by reference in its entirety and which discusses ECN marking in clause 5.8.2.18 which discusses QoS Flow related QoS monitoring and reporting.

In various embodiments when a UPF or other nodes is identified as having congestion, a node (e.g., gNB or UPF) that supports L4S congestion marking will separate data that sets the IP header ECN field to ECT(1) and if congestion is experienced change the ECN field to CE. From an end-to-end perspective, the sending application will perform rate adaptation based on the L4S feedback.

FIG. 8 includes UE 104, NG-RAN 136, e.g., a gNB, AMF 150, SMF 152, UPF1 154, UPF2 156, PSA UPF 158 and DN 162 including application server 806. UE 104 includes client applications 802. Client applications 802 included client application 1 803 and client application 2 804, which requires LLL SF.

In step 808 SMF 152 is operated to provide an indication for ECN marking for LLS to NG-RAN 136, and/or UPF(s) (UPF1 154 and/or UPF2 156 and/or PSA UPF 158 for a corresponding QoS flow. In this example, step 808 includes steps 810, 816, 822 and 824. In step 810 SMF 152 sends configuration signal 812 to NG-RAN (e.g., gNB) 136, to enable congestion monitoring and congestion marking at NG-RAN (e.g., gNB) 136 for a corresponding QoS flow. Circle 813 indicates that configuration signal 812 is communicated via AMF 150. In step 814, NG-RAN (e.g., gNB) 136 receives configuration signal 812 and configures itself to perform congestion monitoring and congestion marking for the QoS flow. In step 816 SMF 152 sends configuration signal 818 to UPF1 154 to enable congestion monitoring and congestion marking at UPF1 154 for the corresponding QoS flow. In step 820, UPF1 154 receives configuration signal 818 and configures itself to perform congestion monitoring and congestion marking for the QoS flow. In step 822 SMF 152 sends configuration signal 824 to UPF2 156 to enable congestion monitoring and congestion marking at UPF2 156 for the corresponding QoS flow. In step 826, UPF2 156 receives configuration signal 824 and configures itself to perform congestion monitoring and congestion marking for the QoS flow. In step 828 SMF 152 sends configuration signal 830 to PSA UPF 158 to enable congestion monitoring and congestion marking at PSA UPF 158 for the corresponding QoS flow. In step 832, PSA UPF 158 receives configuration signal 830 and configures itself to perform congestion monitoring and congestion marking for the QoS flow.

Block 834 indicates the client application 2 (App 2) requires LL SF (ECT1). UE 104 is configured to interpret the requirement that application 2 requires LL SF (ECT) as an implicit indication that IP header ECN field should be set to ECT(1) codepoint.

In step 836 UE 104 generates and sends a PDU session establishment/modification request 838 for client application 2 804 to AMF 150. The PDU session establishment or PDU session modification request 838 includes PDU session ID, required PDU session type, and 5GSM capability information. In step 840 the AMF 150 receives the PDU session establishment/modification request message 838. In response to the received PDU session establishment/modification message 838, in step 842 PDU session establishment or PDU session modification operations are performed.to establish or modify a PDU session between client app 2 804 of UE 104 and an application running of application server 806 of data network 162. Block 844 indicates the QoS flow between NG-RAN (e.g., gNB) 136 and PSA UPF 158 corresponding to the established or modified PDU session includes low latency active queue management (AQM) (ECN marker).

In step 846 UE 104 generates and sends user data with IP header ECN field set to ECT(1) 848 to NG-RAN (e.g., gNB) 136. In step 849 NG-RAN (e.g., gNB) 136 receives the user data with IP header ECN field set to ECT(1). In step 850, NG-RAN (e.g., gNB) 136 determines that congestion is not being experienced in the NG-RAN UL (e.g., based on status of its UL data buffer queues), and generates and sends user data with IP header ECN field set to ECT(1) along the uplink data path. In step 853 UPF1 154 receives the user data with IP header ECN field set to ECT(1) from NG-RAN 136, determines that congestion is not being experienced in the UPF1 UL (e.g., based on status of its UL data buffer queues), and generates and sends user data with IP header ECN field set to ECT(1) along the uplink data path. In step 854 UPF2 156 receives the user data with IP header ECN field set to ECT(1) from UPF1 154, determines that congestion is not being experienced in the UPF2 UL (e.g., based on status of its UL data buffer queues), and generates and sends user data with IP header ECN field set to ECT(1) along the uplink data path. In step 855 PSA UPF 158 receives the user data with IP header ECN field set to ECT(1) from UPF2 156, determines that congestion is not being experienced in the PSA UPF UL (e.g., based on status of its UL data buffer queues), and generates and sends user data with IP header ECN field set to ECT(1) 857 along the uplink data path to the intended application server 806 of DN 162.

At a later point in time, congestion conditions may, and sometimes do, change at one or more of the points along the UL data flow which are monitoring for congestion. Box 860 indicates that NG-RAN (e.g., gNB) 136 monitoring has detected congestion in NG-RAN UL (e.g., based on status of its UL data buffer queues). Box 862 indicates that UPF1 154 monitoring indicates that no congestion is being experienced in UPF1 UL (e.g., based on status of its UL data buffer queues). Box 864 indicates that UPF2 156 monitoring indicates that no congestion is being experienced in UPF2 UL (e.g., based on status of its UL data buffer queues). Box 866 indicates that PSA UPF 158 monitoring indicates that congestion is being experienced in PSA UPF UL (e.g., based on status of its UL data buffer queues).

In step 868 UE 104 generates and sends user data with IP header ECN field set to ECT(1) 870 to NG-RAN (e.g., gNB) 136. In step 872 NG-RAN (e.g., gNB) 136 receives the user data with IP header ECN field set to ECT(1). In step 874, NG-RAN (e.g., gNB) 136, which has determined (860) that congestion is being experienced in the NG-RAN UL (e.g., based on status of its UL data buffer queues), sets ECN to CE. In step 876 NG-RAN (e.g., gNB) 136 generates and sends user data with IP header ECN field set to CE+optionally latest reported congestion information from NG-RAN via GTP-U header 877 along the uplink data path.

In step 878 UPF1 154 receives the user data with IP header ECN field set to CE+optionally latest reported congestion information from NG-RAN via GTP-U header from NG-RAN 136 and forwards the user data with IP header ECN field set to CE+optionally latest reported congestion information from NG-RAN via GTP-U header along the uplink data path.

In step 879 UPF2 156 receives the user data with IP header ECN field set to CE+optionally latest reported congestion information from NG-RAN via GTP-U header from UPF1 154 and forwards the user data with IP header ECN field set to CE+optionally latest reported congestion information from NG-RAN via GTP-U header along the uplink data path.

In step 880 PSA UPF 158 receives the user data with IP header ECN field set to CE+optionally latest reported congestion information from NG-RAN via GTP-U header from UPF1 154 and recovers the communicated information. In step 882, the PSA UPF 158 generates and sends user data with IP header ECN field set to CE along the uplink data path toward application server 806 of ND 162.

In step 886, the application server 806 receives the user data with IP header ECN field set to CE, and in response, in step 890, the application server 806 generates APP 2 L4S feedback. In step 892 application server 806 generates and sends L4S feedback signals 894 conveying application 2 L4S feedback information to client application 2 804 of UE 104, which receives the L4S feedback signals in step 896 and recovers the communicated application 2 (APP2) L4S feedback information.

Operation proceeds from step 896 of FIG. 8A to step 8002 of FIG. 8B. In step 8002 UE 104 performs APP2 L4S rate adaptation, in response to the received APP2 L4S feedback information recovered in step 896.

Following the APP2 L4S rate adaptation implementation of step 8002, congestion conditions change at one of the points along the UL data flow which are monitoring for congestion. Box 8004 indicates that NG-RAN (e.g., gNB) 136 monitoring indicates that no congestion is being experienced in NG-RAN UL (e.g., based on status of its UL data buffer queues). Note: this is a change from step 860 (in which the NG-RAN (e.g., gNB was previously experiencing congestion in NG-RAN UL). Box 8006 indicates that UPF1 154 monitoring indicates that no congestion is being experienced in UPF1 UL (e.g., based on status of its UL data buffer queues). Box 8008 indicates that UPF2 156 monitoring indicates that no congestion is being experienced in UPF2 UL (e.g., based on status of its UL data buffer queues). Box 8010 indicates that PSA UPF 158 monitoring indicates that congestion is still being experienced in PSA UPF UL (e.g., based on status of its UL data buffer queues).

In step 8012 UE 104 generates and sends user data with IP header ECN field set to ECT(1) 8014 to NG-RAN (e.g., gNB) 136. In step 8016 NG-RAN (e.g., gNB) 136 receives the user data with IP header ECN field set to ECT(1). In step 8018, NG-RAN (e.g., gNB) 136 determines that congestion is not being experienced in the NG-RAN UL (e.g., based on status of its UL data buffer queues) (see 8004), and generates and sends user data with IP header ECN field set to ECT(1) 8019 along the uplink data path. In step 8020 UPF1 154 receives the user data with IP header ECN field set to ECT(1) from NG-RAN 136, determines that congestion is not being experienced in the UPF1 UL (e.g., based on status of its UL data buffer queues) (see step 8006), and generates and sends (e.g., forwards) user data with IP header ECN field set to ECT(1) along the uplink data path. In step 8021 UPF2 156 receives the user data with IP header ECN field set to ECT(1) from UPF1 154, determines that congestion is not being experienced in the UPF2 UL (e.g., based on status of its UL data buffer queues) (see step 8008), and generates and sends (e.g., forwards) user data with IP header ECN field set to ECT(1) along the uplink data path. In step 8022 PSA UPF 158 receives the user data with IP header ECN field set to ECT(1) from UPF2 156. In step 8024, PSA UPF 158 sets ECN to CE, based on the determination that congestion is being experienced in the PSA UPF UL (e.g., based on status of its UL data buffer queues) (see step 8010) (see step 8010). In step 8026 the PSA UPF 158 generates and sends user data with IP header ECN field set to CE 8028 along the uplink data path to the intended application server 806 of DN 162.

In step 8030, the application server 806 receives the user data with IP header ECN field set to CE, and in response, in step 8032, the application server 806 generates APP 2 L4S feedback. In step 8034 application server 806 generates and sends L4S feedback signals 8035 conveying application 2 L4S feedback information to client application 2 804 of UE 104, which receives the L4S feedback signals in step 8036 and recovers the communicated application 2 (APP2) L4S feedback information.

In step 8038 UE 104 performs APP2 L4S rate adaptation, in response to the received APP2 L4S feedback information recovered in step 8036. Following the APP2 L4S rate adaptation implementation of step 8038, congestion conditions change at one of the points along the UL data flow which are monitoring for congestion. Box 8040 indicates that NG-RAN (e.g., gNB) 136 monitoring indicates that no congestion is being experienced in NG-RAN UL (e.g., based on status of its UL data buffer queues). Box 8042 indicates that UPF1 154 monitoring indicates that no congestion is being experienced in UPF1 UL (e.g., based on status of its UL data buffer queues). Box 8044 indicates that UPF2 156 monitoring indicates that no congestion is being experienced in UPF2 UL (e.g., based on status of its UL data buffer queues). Box 8046 indicates that PSA UPF 158 monitoring indicates no congestion is being experienced in PSA UPF UL (e.g., based on status of its UL data buffer queues). Note: this is a change from step 8010 (in which the PSA UPF was previously experiencing congestion in PSA UPF UL).

In step 8050 UE 104 generates and sends user data with IP header ECN field set to ECT(1) 8052 to NG-RAN (e.g., gNB) 136. In step 8054 NG-RAN (e.g., gNB) 136 receives the user data with IP header ECN field set to ECT(1). In step 8506, NG-RAN (e.g., gNB) 136 determines that congestion is not being experienced in the NG-RAN UL (e.g., based on status of its UL data buffer queues) (see step 8040), and generates and sends user data with IP header ECN field set to ECT(1) along the uplink data path. In step 8058 UPF1 154 receives the user data with IP header ECN field set to ECT(1) from NG-RAN 136, determines that congestion is not being experienced in the UPF1 UL (e.g., based on status of its UL data buffer queues) (see step 8042), and generates and sends user data with IP header ECN field set to ECT(1) along the uplink data path. In step 8058 UPF2 156 receives the user data with IP header ECN field set to ECT(1) from UPF1 154, determines that congestion is not being experienced in the UPF2 UL (e.g., based on status of its UL data buffer queues) (see step 8044), and generates and sends user data with IP header ECN field set to ECT(1) along the uplink data path. In step 8060 PSA UPF 158 receives the user data with IP header ECN field set to ECT(1) from UPF2 156, determines that congestion is not being experienced in the PSA UPF UL (e.g., based on status of its UL data buffer queues) (see step 8046), and generates and sends user data with IP header ECN field set to ECT(1) 8064 along the uplink data path to the intended application server 806 of DN 162. In step 8066 the application server 8066 receives the user data with IP header ECN field set to ECT(1) 8064 and recovers the communicated information.

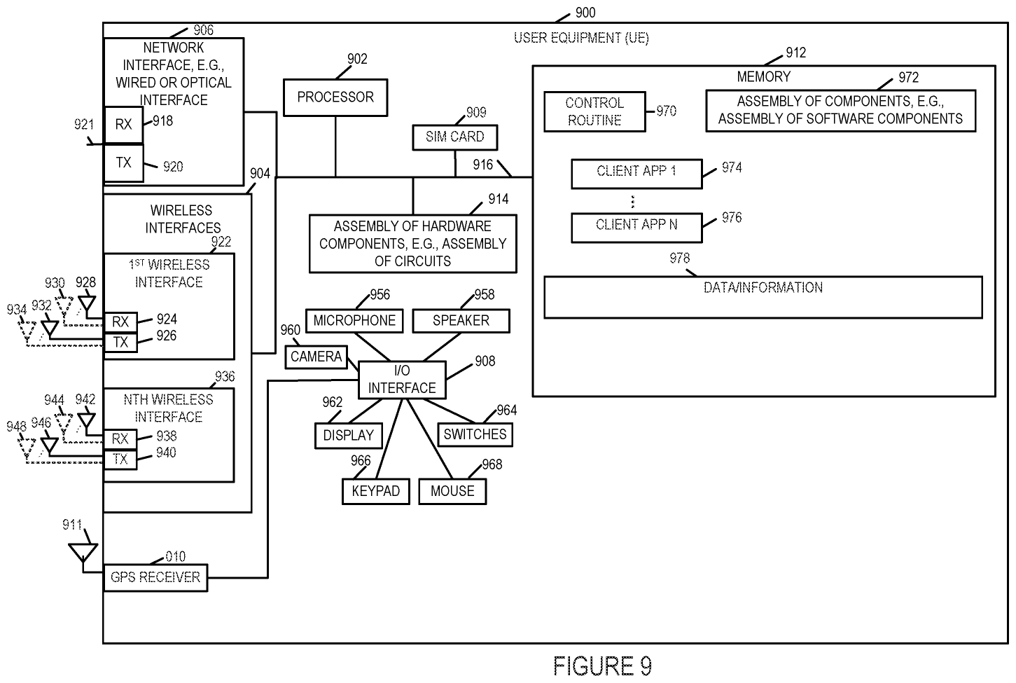

FIG. 9 is a drawing of an exemplary user equipment (UE) 900 in accordance with an exemplary embodiment. Exemplary UE 900 is, e.g., any of the UE devices 102 (UE 1 104, . . . , UE N 106) of system 100 of FIG. 1, of FIGS. 3-8 or UE 206 of FIG. 2. Exemplary UE 900 includes a processor 902, e.g., a CPU, wireless interfaces 904, a network interface 906, an I/O interface 908, a SIM card 909, a GPS receiver 910, memory 912, and an assembly of hardware components 914, e.g., an assembly of circuits, coupled together via a bus 916 over which the various elements may interchange data and information.

Wireless interfaces 908 includes one or more wireless interfaces (1 st wireless interface 922, . . . , Nth wireless interface 936). For example, the 1st wireless interface is a cellular wireless interface, and the Nth wireless interface is a WiFi wireless interface. 1st wireless interface 922 includes a wireless receiver 924 coupled to one or more receive antennas or receive antenna elements (928, . . . , 930), via which the UE 900 may receive wireless signals. 1st wireless interface 922 includes a wireless transmitter 926 coupled to one or more transmit antennas or transmit antenna elements (932, . . . , 934), via which the UE 900 may transmit wireless signals. Nth wireless interface 936 includes a wireless receiver 938 coupled to one or more receive antennas or receive antenna elements (942, . . . , 944), via which the UE 900 may receive wireless signals. Nth wireless interface 936 includes a wireless transmitter 940 coupled to one or more transmit antennas or transmit antenna elements (946, . . . , 948), via which the UE 900 may transmit wireless signals. In some embodiments the same antennas or antenna elements are used for both receive and transmit.

Network interface 906, e.g., a wired or optical interface, includes a receiver 918, a transmitter 920 and connector 921. Network interface 906 may be, and sometimes is, used by UE 900 to communicate with other devices when the UE 900 is located at a premises in which a wireline connection is available.

UE 900 further includes a plurality of I/O devices (microphone 956, speaker 958, camera 960, display 962, switches 964, keypad 966, mouse 968), which are coupled to I/O interface 908. The I/O interface 908 couples the various I/O devices included in UE 900 to other elements within UE 900.

SIM card 909 includes UE subscriber information. GPS receiver 910 is coupled to GPS antenna 911, via which the UE 900 receives GPS signals. The GPS receiver 910 processes the received GPS signals to determine time, UE device position, e.g., latitude, longitude, and altitude, and UE velocity information. In some embodiments, the GPS receiver 910 also perform navigation functions based on processed received GPS signals and/or other received inputs, e.g., inertial measurement information from sensors, e.g., gyroscopes and/or accelerometers (e.g., in an IMU chip) included in UE 900.

Memory 912 includes control routine 970, and assembly of components 972, e.g., an assembly of software components, a plurality of client applications (client application 1 974, . . . , client application 976), and data/information 976. In some embodiments, at least some of the client applications included in client application (974, . . . , 976), are applications requiring L4S.

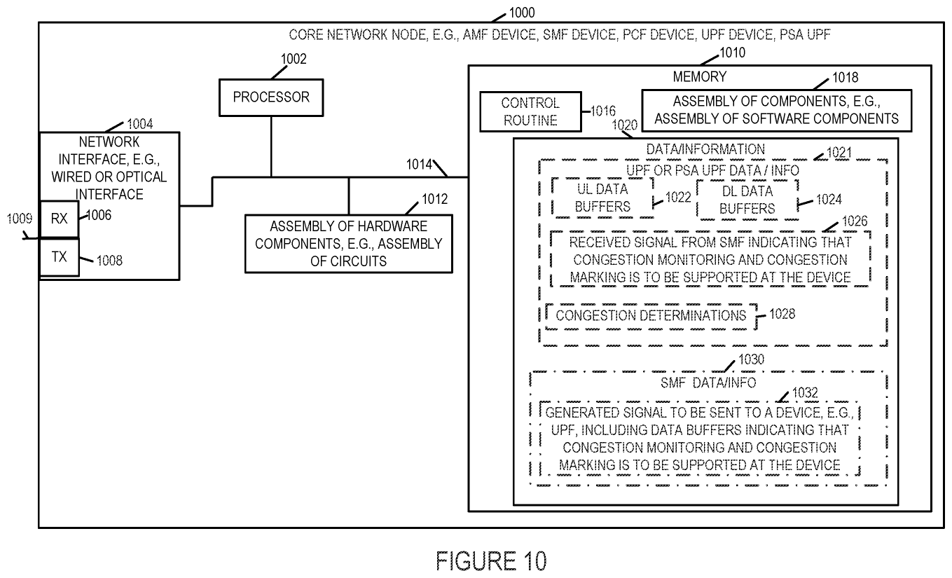

FIG. 10 is a drawing of an exemplary core network node 1000, e.g., an AMF device, a SMF device, a UPF device, a PSA UPF device. Exemplary core network node 1000 is, e.g., any of AMF 150, PCF 151, SMF 152, UPF 1 154, UPF 2 156 or PSA UPF 158 of system 100 of FIG. 1, of FIGS. 3-8, or any of UPF 1 219, UPF 2 223, PSA UPF 227 of FIG. 2. Core network node 1000 includes a processor 1002, e.g., a CPU, a network interface 1004, e.g., a wired or optical interface, and assembly of hardware components 1012, e.g., an assembly of circuits, and memory 1010 coupled together via a bus 1014 over which the various elements may interchange data and information.

Network interface 1004, e.g., a wired or optical interface, includes a receiver 1006, a transmitter 1008 and a connector 1009. Memory 1010 includes a control routine 1016, an assembly of components 1018, e.g., and assembly of software components, and data/information 1020.

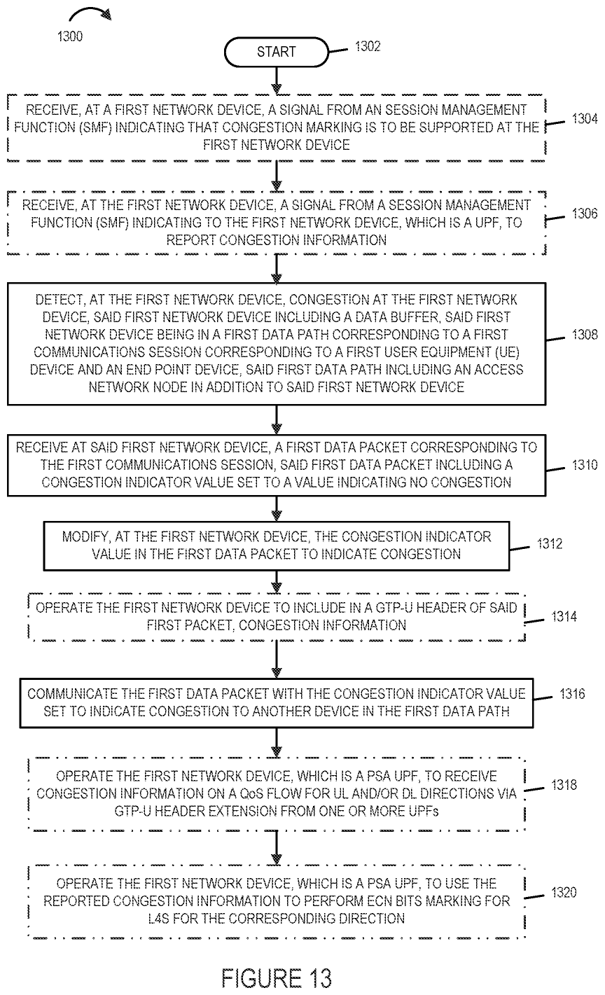

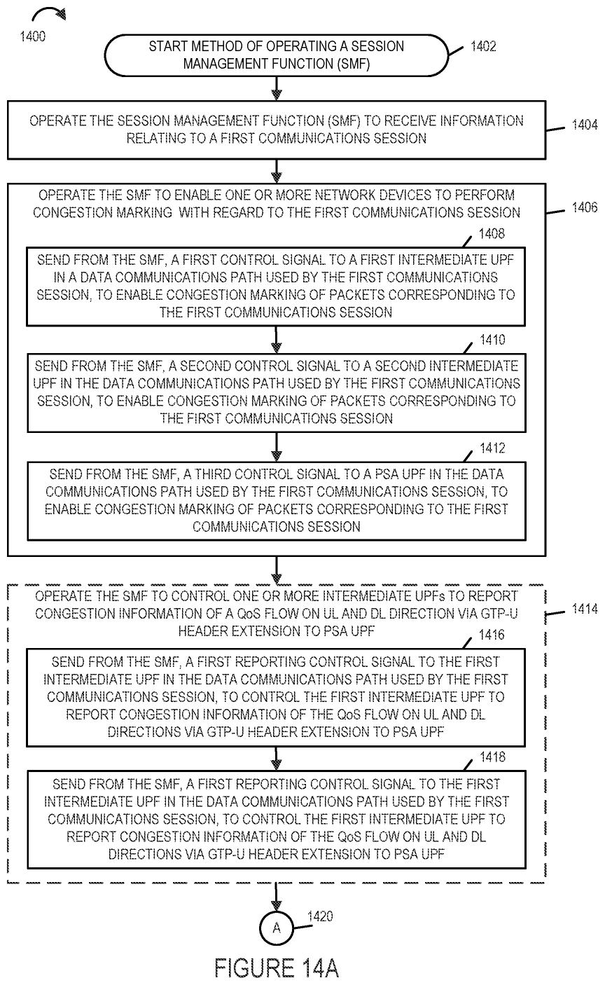

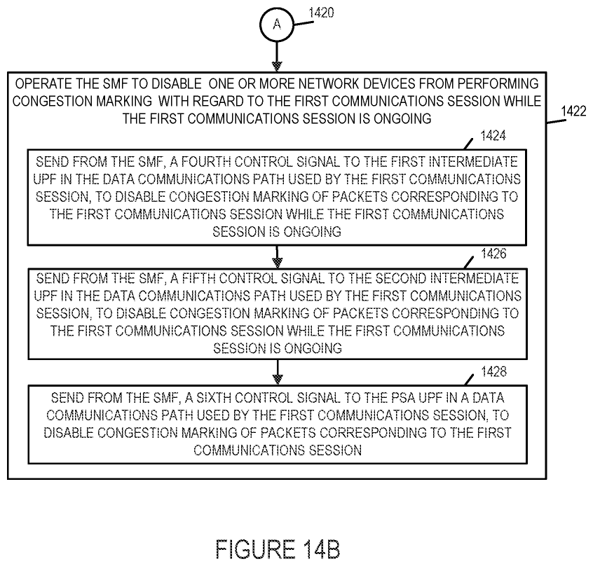

Control routine 1016 includes instructions which when executed by processor 1002 control the core network node 1000 to implement basic operational functions, e.g., read memory, write to memory, control an interface, load a program, subroutine, or app, etc. Assembly of components 1020, e.g., an assembly of software components, e.g., routines, subroutines, applications, etc., includes, e.g., code, e.g., machine executable instructions, which when executed by processor 1002, controls the core network node 1000 to implement steps of a method. For example, when core network node 1000 is a UPF device or PSA UPF device, the assembly of components 1020 includes code, e.g., machine executable instructions, which when executed by processor 1002, controls the core network node 1000 to implement steps of the method of flowchart 1300 of FIG. 13, and/or steps performed by a UPF or PSA UPF, as shown and/or described with respect to any of FIG. 1-8. As another example, when core network node 1000 is a SMF device, the assembly of components 1020 includes code, e.g., machine executable instructions, which when executed by processor 1002, controls the core network node 1000 to implement steps of the method of flowchart 1400 of FIG. 14, and/or steps performed by a SMF, as shown and/or described with respect to any of FIG. 1-8.

In some embodiments, e.g., an embodiment in which the core network node 1000 implements a UPF or a PSA UPF, data information 1021 includes UPF or PSA UPF data/information 1021. Data/information 1021 includes UL data buffers 1022, sometimes referred to as UL data buffer queues, and DL data buffers 1024, sometimes referred to as DL data buffer queues, a received signal from a SMF indicating that congestion monitoring and congesting marking is to be supported at the device 1026, e.g., for a particular PDU traffic flow corresponding to a communications session, and congestion determinations 1028 including, e.g., a current congestion determination for a uplink data flow and a current congestion determination for a downlink data flow. In some embodiments, e.g., an embodiment in which the core network node 1000 implements a SMF, data information 1021 includes SMF data/information 1030. Data/information 1030 includes a generated signal to be sent to a device, e.g., a UPF, including data buffers indicating that congestion monitoring and congestion marking it be supported at the device.

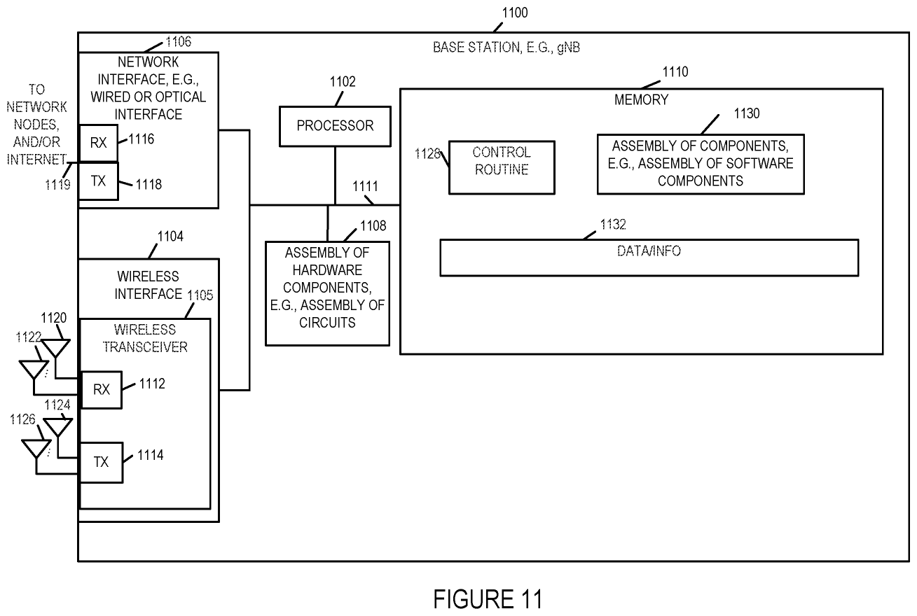

FIG. 11 is a drawing of an exemplary base station 1100, e.g., a gNB, in accordance with an exemplary embodiment. Exemplary base station 1100 is, e.g., any of the gNB 110, gNB 136, or gNB 138 of system 100 of FIG. 1 or FIGS. 3-8 or gNB 215 of FIG. 2. Exemplary base station 1100 includes a processor 1102, e.g., a CPU, wireless interface 1104, a network interface 1106, an assembly of hardware components 1108, e.g., an assembly of circuits, and memory 11010 coupled together via a bus 1111 over which the various elements may interchange data and information.

Wireless interface 1104 includes a wireless receiver 1112 coupled to one or more receive antennas or receive antenna elements (1120, . . . , 1122), via which the base station 1100 may receive wireless signals, e.g., from UEs. Wireless interface 1104 further includes a wireless transmitter 1114 coupled to one or more transmit antennas or transmit antenna elements (1124, . . . , 1126), via which the base station 1100 may transmit wireless signals, e.g., to UEs.

Network interface 1106, e.g., a wired or optical interface, includes a receiver 1116, a transmitter 1118 and connector 1119. Network interface 906 couples the base station 1100 to a core network including core network nodes, e.g., a node implementing an AMF, a node implementing a SMF, nodes implementing UPFs, a node implementing a PSA UPF, etc., to other base stations, and/or to the Internet. Memory 1110 includes control routine 1128, an assembly of components 1130, e.g., an assembly of software components, and data/information 1132.

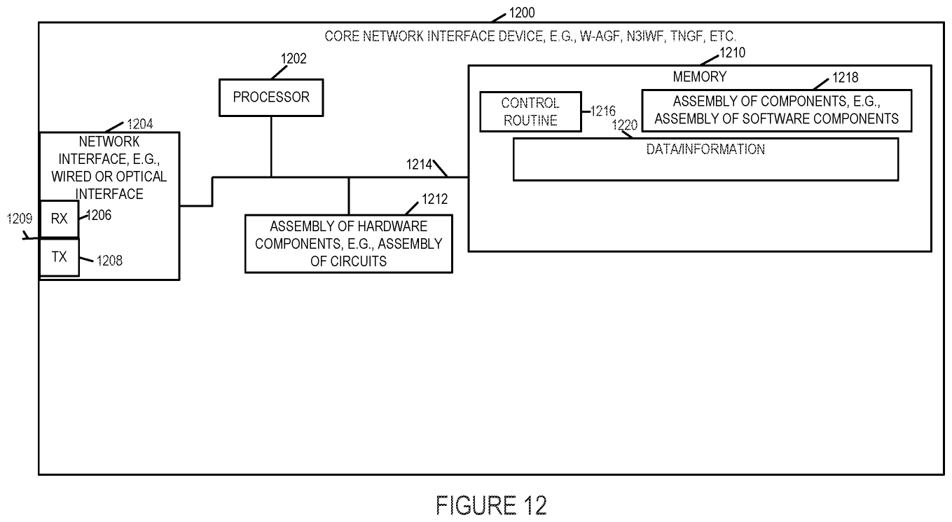

FIG. 12 is a drawing of an exemplary core network interface device 1200, e.g., a W-AGF, N3IWF, TNGF, etc. Core network interface device 1200 is, e.g., any of W-AGF 140, W-AGF 142, N3IWF 144, or TNGF 146 of system 100 of FIG. 1. Core network interface device 1s00 includes a processor 1202, e.g., a CPU, a network interface 1204, e.g., a wired or optical interface, and assembly of hardware components 1212, e.g., an assembly of circuits, and memory 1210 coupled together via a bus 1214 over which the various elements may interchange data and information.

Network interface 1204, e.g., a wired or optical interface, includes a receiver 1206, a transmitter 1208 and a connector 1209. Memory 1210 includes a control routine 1216, an assembly of components 1218, e.g., and assembly of software components, and data/information 1220.

FIG. 13 is a flowchart 1300 of an exemplary method of operating a first network device, e.g., a user plane function (UPF) device, in accordance with an exemplary embodiment. The exemplary network node implementing the method of flowchart 1300 is, e.g., UPF1 154, UPF2 156, or PSA UPF 158. Operation of the exemplary method starts in step 1302 in which the first network device is powered on and initialized. In some embodiments, operation proceeds from start step 1302 to step 1304. In some other embodiments, operation proceeds from start step 1302 to step 1306. In still other embodiments, operation proceeds from start step 1302 to step 1308.

In step 1304 the first network receives a signal from a session management function (SMF) indicating that congestion marking is to be supported at the first network device (e.g., for the first communications session). In some embodiments, the first network device receives the signal from the SMF indicating that congestion marking is to be supported at the first network device as part of Registration procedures. In some embodiments, the first network device receives the signal from the SMF indicating that congestion marking is to be supported at the first network device as part of Protocol Data Unit (PDU) session procedures (e.g., PDU Session Establishment or PDU Session Modification procedures).

In some embodiments, the signal from the SMF instructs the first network device to perform both congestion information monitoring and congestion marking. In some embodiments, the congestion monitoring involves monitoring one or more data buffers (e.g., data buffer queues) of the first network device.

In some embodiments, operation proceeds from step 1304 to step 1306. In some other embodiments, operation proceeds from step 1304 to step 1308.

In step 1306 the first network device (e.g., a non-PSA UPF) receives a signal from a session management function (SMF) indicating to the first network device, which is a UPF (e.g., a non-PSA UPF), to report congestion information (i.e., a percentage of packets that it uses for ECN marking for L4S of the QoS flow on UL and DL directions via GTP-U header extension to PSA UPF. Operation proceeds from step 1306 to step 1308.

In step 1308 the first network device detects congestion at the first network device, said first network device including a data buffer, said first network device being in a first data path corresponding to a first communications session corresponding to a first user equipment (UE) device and an end point device (e.g., an application server, wherein the application server and the first UE are different end point devices of the first communications session), said first data path including an access network (AN) node (e.g., a RAN node, e.g. a gNB) in addition to said first network device. In some embodiments, the first communications session is a PDU (protocol data unit) session. Operation proceeds from step 1308 to step 1310.

In step 1310 the first network device receives a first data packet corresponding to the first communications session, said first data packet including a congestion indicator value (e.g., a ECN value) set to a value indicating no congestion (e.g., the ECN field value in the PDU IP header is set to a value which indicates ECT(1)). In some embodiments, the first data packet is an IP packet. In some such embodiments, the congestion indicator value is communicated in ECN bits (e.g., in an ECN field) in an IP header. In some embodiments the congestion indicator value is used to support L4S (Low Latency, Low Loss and Scalable Throughput) applications. Operation proceeds from step 1310 to step 1312.

In step 1312 the first network node modifies the congestion indicator value in the first data packet to indicate congestion (e.g., set the ECN field value in the PDU IP header to a value which indicates CE). In some embodiments, operation proceeds from step 1312 to step 1314. In other embodiments, operation proceeds from step 1312 to step 1316.

In step 1314 the first network device is operated to include in a GTP-U header of said first packet, congestion information (i.e., a percentage of packets that it uses for ECN marking for L4S). Operation proceeds from step 1314 to step 1316.

In step 1316 the first network device communicates, e.g., sends, the first data packet with the congestion indicator value set to indicate congestion to another device in the first data path.

In some embodiments, the first network device is a PSA UPF device, and operation proceeds from step 1316 to step 1318. In step 1318 the first network device, which is a PSA UPF is operated to receive congestion information (e.g., a percentage of packets that it uses for ECN marking for L4S) on a QoS flow for UL and/or DL directions via GTP-U header extension from one or more UPFs. Operation proceeds from step 1318 to step 1320.

In step 1320 the first network device, which is a PSA UPF, is operated to use the reported congestion information to perform Explicit Congestion Notification (ECN) bits marking for L4S for the corresponding direction.

In some embodiment, the first network device is a user plane function (UPF) device. In some such embodiments, the UPF device is implemented in a cloud. In some embodiments, the UPF device is implemented in a distributed manner using one or more cloud-based components (e.g., processor, memory, communications interfaces) to provide UPF services to the first communications session. In some embodiments, the UPF device is a non-anchor UPF (e.g., is not operating as a PDU Session Anchor (PSA) UPF for the first communications session and is one of one or more intermediate UPFs in the first communications path.

In some embodiments, the first network device is one of a plurality of UPFs along the first data path which are enabled to detect congestion and perform congestion marking. In some embodiments, the first communications path (e.g., the first data path) is one of an uplink communications path (e.g., uplink data path) and a downlink communications path (e.g., downlink data path).

FIG. 14, comprising the combination of FIG. 14A and FIG. 14B, is a flowchart 1400 of an exemplary method of operating a session management function (SMF) device in accordance with an exemplary embodiment. The exemplary SMF implementing the method of flowchart 1400 is, e.g., SMF 152. Operation of the exemplary method starts in step 1402, in which the SMF is powered on and initialized. Operation proceeds from start step 1402 to step 1404. In step 1404 the SMF is operated to receive information relating to a first communications session. Operation proceeds from step 1404 to step 1406.

In step 1406 the SMF is operated to enable one or more network devices to perform congestion marking with regard to the first communications session. Step 1406 includes steps 1408, 1410 and 1412.

In step 1408 the SMF sends a first control signal to a first intermediate UPF, e.g., UPF1 154, in a data communications path used by the first communications session, to enable congestion marking of packets corresponding to the first communications session (e.g., with in some embodiments uplink and downlink congestion marking being enabled individually and/or with marking for data packets communicated in one direction being enabled but not the other direction, e.g., uplink marking is enabled for the first communications session but not downlink marking).

In some embodiments, the first control signal enables marking by the first intermediate UPF in an uplink direction. In some embodiments, the first control signal enables marking by the first intermediate UPF in a downlink direction. In some embodiments, the first control signal enables marking by the first intermediate UPF in both an uplink direction and a downlink direction.

In some embodiments, first control signal further controls the first intermediate UPF to monitor for congestion at the first intermediate UPF and perform congestion marking based on congestion detected at the first intermediate UPF (enabling of congestion monitoring at a network node such as a UPF may be and sometimes is controlled on a per uplink and/or downlink basis and may be and sometimes is controlled on a per data session basis with a node being controlled to perform congestion monitoring for some communications sessions having data passing through the node and not for other communications sessions which have data packets passing through the node).

In some embodiments, the first control signal further controls the first intermediate node to perform congestion reporting based on congestion detected at the first intermediate node.

In step 1410 the SMF sends a second control signal to a second intermediate UPF, e.g., UPF2 156, in a data communications path used by the first communications session, to enable congestion marking of packets corresponding to the first communications session (e.g., with in some embodiments uplink and downlink congestion marking being enabled individually and/or with marking for data packets communicated in one direction being enabled but not the other direction, e.g., uplink marking is enabled for the first communications session but not downlink marking.

In some embodiments, second control signal further controls the second intermediate UPF to monitor for congestion at the second intermediate UPF and perform congestion marking based on congestion detected at the second intermediate UPF (enabling of congestion monitoring at a network node such as a UPF may be and sometimes is controlled on a per uplink and/or downlink basis and may be and sometimes is controlled on a per data session basis with a node being controlled to perform congestion monitoring for some communications sessions having data passing through the node and not for other communications sessions which have data packets passing through the node).

In some embodiments, the second control signal further controls the second intermediate node to perform congestion reporting based on congestion detected at the second intermediate node.

In step 1412 the SMF sends a third control signal to a PSA UPF, e.g., PSA UPF 158, in a data communications path used by the first communications session, to enable congestion marking of packets corresponding to the first communications session (e.g., with in some embodiments uplink and downlink congestion marking being enabled individually and/or with marking for data packets communicated in one direction being enabled but not the other direction, e.g., uplink marking is enabled for the first communications session but not downlink marking.

In some embodiments, third control signal further controls the PSA UPF to monitor for congestion at the PSA UPF and perform congestion marking based on congestion detected at the PSA UPF (enabling of congestion monitoring at a network node such as a PSA UPF may be and sometimes is controlled on a per uplink and/or downlink basis and may be and sometimes is controlled on a per data session basis with a node being controlled to perform congestion monitoring for some communications sessions having data passing through the node and not for other communications sessions which have data packets passing through the node).

In some cases marking is enabled for some UPFs in the data communications path of the first communications session and not for other UPFs in the data path. Congestion marking enablement may be, and sometimes is, on a per communications session basis with the SMF indicating to a UPF via control signals one or more communications sessions, e.g., PDU sessions, for which congestion marking is to be implemented on an uplink and/or downlink basis while congestion marking is not enabled for other communications sessions passing through the same UPF).

In some embodiments, operation proceeds from step 1406 to optional step 1414. In other embodiments, operation proceeds from step 1406 to step 1422, via connecting node A 1420 and bypasses optional step 1414.

Returning to step 1414, in step 1414 the SMF is operated to control one or more intermediate UPS to report congestion information of QoS on UL and DL direction via GTP-U header extension to PSA UPF. Step 1414 includes steps 1416 and 1418. In step 1416 the SMF sends a first reporting control signal to the first intermediate UPF in the data communication path used for the first communications session, to control the first intermediate UPF to report congestion information (i.e., a percentage of packets that it uses for ECN marking for L4S) of the QoS flow on UL and DL directions via GTP-U header extension to PSA UPF. In step 1418 the SMF sends a second reporting control signal to the second intermediate UPF in the data communication path used for the first communications session, to control the second intermediate UPF to report congestion information of the QoS flow on UL and DL directions via GTP-U header extension to PSA UPF. Operation proceeds from step 1414, via connecting node A 1420 to step 1422.

In step 1422 the SMF is operated to disable one or more network devices from performing congestion marking with regard to the first communications session while the first communications session is ongoing. Step 1422 includes steps 1424, 1426 and 1428. In step 1424 the SMF sends a fourth control signal (e.g., a disable marking control signal) to the first intermediate UPF in the data communications path used by the first communications session, to disable congestion marking with regard to packets corresponding to the first communications session while the first communications session is ongoing (disabling of marking may be, and sometimes is, on a per direction basis with congestion marking in the uplink or downlink being disabled while marking in the other direction is still enabled in some cases).

In step 1426 the SMF sends a fifth control signal (e.g., a disable marking control signal) to the second intermediate UPF in the data communications path used by the first communications session, to disable congestion marking with regard to packets corresponding to the first communications session while the first communications session is ongoing (disabling of marking may be, and sometimes is, on a per direction basis with congestion marking in the uplink or downlink being disabled while marking in the other direction is still enabled in some cases).

In step 1428 the SMF sends a sixth control signal (e.g., a disable marking control signal) to the PSA UPF in the data communications path used by the first communications session, to disable congestion marking with regard to packets corresponding to the first communications session while the first communications session is ongoing (disabling of marking may be, and sometimes is, on a per direction basis with congestion marking in the uplink or downlink being disabled while marking in the other direction is still enabled in some cases).

Numbering in each of the following lists to an earlier numbered embodiment refers to a numbered embodiment in the same list.

### First Numbered List of Exemplary Method Embodiments:

Method Embodiment 1. A communications method, the method comprising: detecting (1308) congestion at a first network device (e.g., UPF) including a data buffer, said first network device being in a first data path corresponding to a first communications session corresponding to a first user equipment (UE) device and an end point device (e.g., an application server, wherein the application server and first UE are different end point devices of the first communications session), said first data path including an access network (AN) node (e.g., RAN node, e.g. a gNB) in addition to said first network device; receiving (1310), at the first network device, a first data packet corresponding to the first communications session, said first data packet including a congestion indicator value (e.g., an ECN value) set to a value indicating no congestion (e.g., the ECN field value in PDU IP header is set to a value which indicates ECT(1)); modifying (1312), at the first network device, the congestion indicator value in the first data packet to indicate congestion (e.g., set the ECN field value in the PDU IP header to a value which indicates CE); and communicating (1316), from the first network device, the first data packet with the congestion indicator value set to indicate congestion to another device in the first data path.

Method Embodiment 1a. The method of Method Embodiment 1, wherein said first communications session is a PDU (protocol data unit) session.

Method Embodiment 1b. The method of Method Embodiment 1, wherein said first data packet is IP packet.

Method Embodiment 1c. The method of Method Embodiment 1b, wherein said congestion indicator value is communicated in ECN bits (e.g., in an ECN field) in an IP header.

Method Embodiment 1d. The method of Method Embodiment 1, wherein the congestion indicator value is used to support L4S (Low Latency, Low Loss and Scalable Throughput) applications.

Method Embodiment 2. The method of Method Embodiment 1, wherein the first network device is a user plane function (UPF) device.

Method Embodiment 2A. The method of Method Embodiment 2, wherein said UPF device is implemented in a cloud.

Method Embodiment 2B. The method of Method Embodiment 2, wherein said UPF device is implemented in a distributed manner using one or more cloud-based components (e.g., processor, memory, communications interfaces) to provide UPF service to the first communications session.

Method Embodiment 3. The method of Method Embodiment 2, wherein the UPF device is a non-anchor UPF (e.g., is not operating as a PDU Session Anchor (PSA) UPF for the first communications session and is one of one or more intermediate UPFs in said first communications path).

Method Embodiment 4. The method of Method Embodiment 3, further comprising: receiving (1304), at the first network device, a signal from a Session Management Function (SMF) indicating that congestion marking is to be supported at the first network device (e.g., for the first communications session).

Method Embodiment 5. The method of Method Embodiment 2, wherein said first network device is one of a plurality of UPFs along the first data path which are enabled to detect congestion and perform congestion marking.

Method Embodiment 6. The method of Method Embodiment 1, wherein said first communications path is one of an uplink communication path and a downlink communication path.

Method Embodiment 7. The method of Method Embodiment 4, wherein the first network device receives the signal from the SMF indicating that congestion marking is to be supported at the first network device as part of Registration procedures.

Method Embodiment 8. The method of Method Embodiment 4, wherein the first network device receives the signal from the SMF indicating that congestion marking is to be supported at the first network device as part of Protocol Data Unit (PDU) session procedures (e.g., PDU Session Establishment or PDU Session Modification procedures).

Method Embodiment 9. The method of Method Embodiment 4, wherein said signal from the SMF instructs the first network device to perform both congestion information monitoring and congestion marking.

Method Embodiment 9A. The method of Method Embodiment 4, wherein the congestion monitoring involves monitoring one or more data buffers of the first network device.

Method Embodiment 10. The method of Method Embodiment 4, wherein said first network device is a UPF (e.g., a non-PSA UPF), the method further comprising: receiving (1306), at the first network device, a signal from the SMF indicating to the UPF to report congestion information (i.e., a percentage of packets that it uses for ECN marking for L4S) of the QoS flow on UL and DL directions via GTP-U header extension to PSA UPF.

Method Embodiment 10A. The method of Method Embodiment 10, further comprising: operating (1314) the first network device to include in a GTP-U header of said first packet congestion information (i.e., a percentage of packets that it uses for ECN marking for L4S).

Method Embodiment 11. The method of Method Embodiment 1, wherein said first network node is a PSA UPF, the method further comprising: receiving (1318) reported congestion information (i.e., a percentage of packets that it uses for ECN marking for L4S) of the QoS flow on UL and DL directions via GTP-U header extension from one or more to UPFs; and using (1320) the received reported congestion information to perform Explicit Congestion Notification (ECN) bits marking for L4S for the corresponding direction.

### First Numbered List of Exemplary Apparatus Embodiments:

Apparatus Embodiment 1. A first network device (UPF 1 154 or UPF 2 156 or PSA UPF 158 or UPF 1 219 or UPF 2 223 or PSA UPF 227 or core network node 1000 which is a UPF device or a PSA UPF device) in a communications network (100), the first network device comprising: a data buffer (221 or 225 or 229 or 1022 or 1024); a communications interface (1004) including a receiver (1006) and a transmitter (1008); a processor (1002) configured to control the first network device to: detect congestion at a first network device (e.g., UPF) including said data buffer, said first network device being in a first data path corresponding to a first communications session corresponding to a first UE device (104 or 900) and an end point device (e.g., an application server (162 or 218 or 806), where the application server and first UE device are different end point devices of the first communications session), said data path including an access network (AN) node (e.g., RAN node, e.g. a gNB) (138 or 1100) in addition to said first network device; receive, at the first network device, a first data packet corresponding to the first communications session, said first data packet including a congestion indicator value (e.g., an ECN value) set to a value indicating no congestion (e.g., the ECN field value in PDU IP header is set to a value which indicates ECT(1)); modify the congestion indicator value in the first data packet to indicate congestion (e.g., set the ECN field value in the PDU IP header to a value which indicates CE); and communicate the first data packet with the congestion indicator value set to indicate congestion to another device in the first data path.

Apparatus Embodiment 1a. The first network device of Apparatus Embodiment 1, wherein said first communications session is a PDU (protocol data unit) session.

Apparatus Embodiment 1b. The first network device of Apparatus Embodiment 1, wherein said first data packet is IP packet.

Apparatus Embodiment 1c. The first network device of Apparatus Embodiment 1b, wherein said congestion indicator value is communicated in ECN bits (e.g., in an ECN field) in an IP header.

Apparatus Embodiment 1d. The first network device of Apparatus Embodiment 1, wherein the congestion indicator value is used to support L4S (Low Latency, Low Loss and Scalable Throughput) applications.

Apparatus Embodiment 2. The first network device of Apparatus Embodiment 1, wherein the first network device is a user plane function (UPF) device.

Apparatus Embodiment 2A. The first network device of Apparatus Embodiment 2, wherein said UPF device is implemented in a cloud.

Apparatus Embodiment 2B. The first network device of Apparatus Embodiment 2, wherein said UPF device is implemented in a distributed manner using one or more cloud-based components (e.g., processor, memory, communications interfaces) to provide UPF service to the first communications session.

Apparatus Embodiment 3. The first network device of Apparatus Embodiment 2, wherein the UPF device is a non-anchor UPF (e.g., UPF1 154 or UPF2 156) (e.g., is not operating as a PDU Session Anchor (PSA) UPF for the first communications session and is one of one or more intermediate UPFs in said first communications path).

Apparatus Embodiment 4. The first network of Apparatus Embodiment 3, wherein said processor is further configured to control the first network device to: receive (1304), at the first network device, a signal from a Session Management Function (SMF) (e.g., SMF 152) indicating that congestion marking is to be supported at the first network device (e.g., for the first communications session).

Apparatus Embodiment 5. The first network device of Apparatus Embodiment 2, wherein said first network device is one of a plurality of UPFs (e.g., UPF 1 541, UPF2 156, PSA UPF 158) along the first data path which are enabled to detect congestion and perform congestion marking.

Apparatus Embodiment 6. The first network device of Apparatus Embodiment 1, wherein said first communications path is one of an uplink communication path and a downlink communication path.

Apparatus Embodiment 7. The first network device of Apparatus Embodiment 4, wherein the first network device receives the signal from the SMF indicating that congestion marking is to be supported at the first network device as part of Registration procedures.

Apparatus Embodiment 8. The first network device of Apparatus Embodiment 4, wherein the first network device receives the signal from the SMF indicating that congestion marking is to be supported at the first network device as part of Protocol Data Unit (PDU) session procedures (e.g., PDU Session Establishment or PDU Session Modification procedures).

Apparatus Embodiment 9. The first network device of Apparatus Embodiment 4, wherein said signal from the SMF instructs the first network device to perform both congestion information monitoring and congestion marking.

Apparatus Embodiment 9A. The first network device of Apparatus Embodiment 4, wherein the congestion monitoring involves monitoring one or more data buffers of the first network device.

Apparatus Embodiment 10. The first network device of Apparatus Embodiment 4, wherein said first network device is a UPF (e.g., a non-PSA UPF) (e.g., UPF1 154 or UPF2 156), and wherein said processor is further configured to control the first network device to: receive (1306), at the first network device, a signal from the SMF indicating to the UPF to report congestion information (i.e., a percentage of packets that it uses for ECN marking for L4S) of the QoS flow on UL and DL directions via GTP-U header extension to PSA UPF.

Apparatus Embodiment 10A. The first network device of Apparatus Embodiment 10, wherein said processor is further configured to control the first network device to: operate (1314) the first network device to include in a GTP-U header of said first packet congestion information (i.e., a percentage of packets that it uses for ECN marking for L4S).

Apparatus Embodiment 11. The first network device of Apparatus Embodiment 1, wherein said first network node is a PSA UPF (e.g. PSA UPF 158); and wherein said processor is further configured to control the first network device to: receive (1318) reported congestion information (i.e., a percentage of packets that it uses for ECN marking for L4S) of the QoS flow on UL and DL directions via GTP-U header extension from one or more to UPFs; and use (1320) the received reported congestion information to perform Explicit Congestion Notification (ECN) bits marking for L4S for the corresponding direction.

### First Numbered List of Exemplary Non-Transitory Computer Readable Medium Embodiments:

### Non-Transitory Computer Readable Medium Embodiment 1.

A Non-Transitory Computer Readable Medium (1010) include machine executable instructions, which when executed by a processor (1002) of first network device (UPF1 154, UPF 2 156, PSA UPF 158, UPF1 219, UPF2 223, PSA UPF 227, or core network node 1000 which is a UPF device or a PSA UPF device), control the first network device to perform the steps of: detecting (1308) congestion at a first network device (e.g., UPF) including a data buffer, said first network device being in a first data path corresponding to a first communications session corresponding to a first user equipment (UE) device and an end point device (e.g., an application server, wherein the application server and first UE are different end point devices of the first communications session), said first data path including an access network (AN) node (e.g., RAN node, e.g. a gNB) in addition to said first network device; receiving (1310), at the first network device, a first data packet corresponding to the first communications session, said first data packet including a congestion indicator value (e.g., an ECN value) set to a value indicating no congestion (e.g., the ECN field value in PDU IP header is set to a value which indicates ECT(1)); modifying (1312), at the first network device, the congestion indicator value in the first data packet to indicate congestion (e.g., set the ECN field value in the PDU IP header to a value which indicates CE); and communicating (1316), from the first network device, the first data packet with the congestion indicator value set to indicate congestion to another device in the first data path.

### Second Numbered List of Exemplary Method Embodiments:

Method Embodiment 1. A method of operating a session management function (SMF), the method comprising: operating (1404) the SMF to receive information relating to a first communications session; and operating (1406) the SMF to enable one or more network devices to perform congestion marking with regard to the first communications session.

Method Embodiment 2. The method of Method Embodiment 1, wherein operating (1406) the SMF to enable one or more network devices to perform congestion marking with regard to the first communications session includes: sending (1408), from the SMF, a first control signal to a first intermediate user plane function (UPF) in a data communications path used by the first communications session, to enable congestion marking of packets corresponding to the first communications session (e.g., with in some embodiments uplink and downlink congestion marking being enabled individually and/or with marking for data packets communicated in one direction being enabled but not the other direction, e.g., uplink marking is enabled for the first communications session but not downlink marking).

Method Embodiment 3. The method of Method Embodiment 2, wherein the first control signal enables marking by the first intermediate UPF in an uplink direction.

Method Embodiment 4. The method of Method Embodiment 2, wherein the first control signal enables marking by the first intermediate UPF in a downlink direction.

Method Embodiment 4A. The method of Method Embodiment 2, wherein the first control signal enables marking by the first intermediate UPF in both an uplink direction and a downlink direction.

Method Embodiment 5. The method of Method Embodiment 2, wherein said first control signal further controls the first intermediate UPF to monitor for congestion at the first intermediate UPF and perform congestion marking based on congestion detected at the first intermediate UPF (enabling of congestion monitoring at a network node such as a UPF may be and sometimes is controlled on a per uplink and/or downlink basis and may be and sometimes is controlled on a per data session basis with a node being controlled to perform congestion monitoring for some communications sessions having data passing through the node and not for other communications sessions which have data packets passing through the node).

Method Embodiment 5A. The method of Method Embodiment 2, wherein the first control signal further controls the first intermediate node to perform congestion reporting based on congestion detected at the first intermediate node.

Method Embodiment 6. The method of Method Embodiment 2, further comprising: operating (1424) the SMF (e.g., by sending a disable marking control signal to the first intermediate UPF) to disable congestion marking with regard to the first communications session at the first intermediate UPF while the communications session is ongoing (disabling of marking may be, and sometimes is, on a per direction basis with congestion marking in the uplink or downlink being disabled while marking in the other direction is still enabled in some cases).

Method Embodiment 7. The method of Method Embodiment 2, further comprising sending (1416) a reporting control signal from the SMF, to the first intermediate UPF, to control the intermediate to report congestion information (i.e., a percentage of packets that it uses for ECN marking for L4S) of a QoS flow on UL and DL directions via GTP-U header extension to PSA UPF.

Method Embodiment 8. The method of Method Embodiment 2, wherein operating the SMF to enable one or more network devices to perform congestion marking with regard to the first communications session includes: sending (1410), from the SMF, a second control signal to a second intermediate UPF in a data communications path used by the first communications session, to enable congestion marking of packets corresponding to the first communications session at the second intermediate UPF (e.g., with in some embodiments uplink and downlink congestion marking being enabled individually and/or with marking for data packets communicated in one direction being enabled but not the other direction, e.g., uplink marking is enabled for the first communications session but not downlink marking. In some cases, marking is enabled for some UPFs in the data communications path of the first communications session and not for other UPFs in the data path. Congestion marking enablement may be and sometimes is on a per communications session basis with the SMF indicating to a UPF via control signals one or more communications sessions, e.g., PDU sessions, for which congestion marking is to be implemented on an uplink and/or downlink basis while congestion marking is not enabled for other communications sessions passing through the same UPF).

### Second Numbered List of Exemplary Apparatus Embodiments

Apparatus Embodiment 1. A session management function (SMF) device (152 or 1000), comprising: memory (1010), a communications interface (1004) including a receiver (1006) and a transmitter (1008); and a processor (1002) configured to control the SMF (152 or 1000) to: receive information relating to a first communications session; and enable (e.g., by sending control signals to the devices to be enabled to perform congestion marking and/or monitoring) one or more network devices (e.g., UPF1 154, UPF2 156, PSA UPF 158) to perform congestion marking with regard to the first communications session.

Apparatus Embodiment 2. The SMF device of Apparatus Embodiment 1, wherein said processor is configured to control the SMF to: send (1408), from the SMF, a first control signal to a first intermediate user plane function (UPF) in a data communications path used by the first communications session, to enable congestion marking of packets corresponding to the first communications session, as part of being configured to control the SMF to enable one or more network devices to perform congestion marking with regard to the first communications session (e.g., with in some embodiments uplink and downlink congestion marking being enabled individually and/or with marking for data packets communicated in one direction being enabled but not the other direction, e.g., uplink marking is enabled for the first communications session but not downlink marking).

Apparatus Embodiment 3. The SMF device of Apparatus Embodiment 2, wherein the first control signal enables marking by the first intermediate UPF in an uplink direction.

Apparatus Embodiment 4. The SMF device of Apparatus Embodiment 2, wherein the first control signal enables marking by the first intermediate UPF in a downlink direction.

Apparatus Embodiment 4A. The SMF device of Apparatus Embodiment 2, wherein the first control signal enables marking by the first intermediate UPF in both an uplink direction and a downlink direction.

Apparatus Embodiment 5. The SMF device of Apparatus Embodiment 2, wherein said first control signal further controls the first intermediate UPF to monitor for congestion at the first intermediate UPF and perform congestion marking based on congestion detected at the first intermediate UPF (enabling of congestion monitoring at a network node such as a UPF may be and sometimes is controlled on a per uplink and/or downlink basis and may be and sometimes is controlled on a per data session basis with a node being controlled to perform congestion monitoring for some communications sessions having data passing through the node and not for other communications sessions which have data packets passing through the node).

Apparatus Embodiment 5A. The SMF device of Apparatus Embodiment 2, wherein the first control signal further controls the first intermediate node to perform congestion reporting based on congestion detected at the first intermediate node.

Apparatus Embodiment 6. The SMF device of Apparatus Embodiment 2, wherein said processor is further configured to control the SMF device to: operate (1424) the SMF (e.g., by sending a disable marking control signal to the first intermediate UPF) to disable congestion marking with regard to the first communications session at the first intermediate UPF while the communications session is ongoing (disabling of marking may be, and sometimes is, on a per direction basis with congestion marking in the uplink or downlink being disabled while marking in the other direction is still enabled in some cases).

Apparatus Embodiment 7. The SMF device of Apparatus Embodiment 2, wherein said processor is further configured to control the SMF device to: send (1416) a reporting control signal from the SMF, to the first intermediate UPF, to control the intermediate to report congestion information (i.e., a percentage of packets that it uses for ECN marking for L4S) of a QoS flow on UL and DL directions via GTP-U header extension to PSA UPF.

Apparatus Embodiment 8. The SMF device of Apparatus Embodiment 2, wherein said processor is configured to control the SMF device to: send (1410), from the SMF, a second control signal to a second intermediate UPF in a data communications path used by the first communications session, to enable congestion marking of packets corresponding to the first communications session at the second intermediate UPF, as part of being configured to operate the SMF to enable one or more network devices to perform congestion marking with regard to the first communications session (e.g., with in some embodiments uplink and downlink congestion marking being enabled individually and/or with marking for data packets communicated in one direction being enabled but not the other direction, e.g., uplink marking is enabled for the first communications session but not downlink marking).

### Second Numbered List of Exemplary Non-Transitory Computer Readable Medium Embodiments:

### Non-Transitory Computer Readable Medium Embodiment 1.

A Non-Transitory Computer Readable Medium (1010) include machine executable instructions, which when executed by a processor (1002) of a SMF device (SMF 152 or core node 1000 which is a SMF device), control the SMF device to perform the steps of: operating (1404) the SMF to receive information relating to a first communications session; and operating (1406) the SMF to enable one or more network devices (e.g., UPF1 154, UPF2 156, PSA UPF 158) to perform congestion marking with regard to the first communications session.

The techniques of various embodiments may be implemented using software, hardware and/or a combination of software and hardware. Various embodiments are directed to apparatus, e.g., user equipment (UE) devices, core network devices (e.g., PCF devices, AMF devices, SMF devices, UPF devices, etc.), access network devices (e.g., base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating user equipment (UE) devices, core network devices (e.g., PCF devices, AMF devices, SMF devices, UPF devices, etc.), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., user equipment (UE) devices, core network devices (e.g., PCF devices, AMF devices, SMF devices, UPF devices, etc.), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., user (UE) devices, core network devices (e.g., PCF devices, AMF devices, SMF devices, UPF devices, etc.), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a user equipment (UE) devices, core network devices (e.g., PCF devices, AMF devices, SMF devices, UPF devices, etc.), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., user equipment (UE) devices, core network devices (e.g., PCF devices, AMF devices, SMF devices, UPF devices, etc.), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., user (UE) devices, core network devices (e.g., PCF devices, AMF devices, SMF devices, UPF devices, etc.), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a user equipment (UE) device, core network device (e.g., PCF device, AMF device, SMF device, UPF device, etc.), wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communications method, the method comprising:
detecting congestion at a first network device including a data buffer, said first network device being in a first data path corresponding to a first communications session corresponding to a first user equipment (UE) device and an end point device, said first data path including an access network (AN) node in addition to said first network device;
receiving, at the first network device, a first data packet corresponding to the first communications session, said first data packet including a congestion indicator value set to a value indicating no congestion;
modifying, at the first network device, the congestion indicator value in the first data packet to indicate congestion; and
communicating, from the first network device, the first data packet with the congestion indicator value set to indicate congestion to another device in the first data path.

2. The method of claim 1, wherein the first network device is a user plane function (UPF) device.

3. The method of claim 2, wherein the UPF device is a non-anchor UPF.

4. The method of claim 3, further comprising:
receiving, at the first network device, a signal from a Session Management Function (SMF) indicating that congestion marking is to be supported at the first network device.

5. The method of claim 2, wherein said first network device is one of a plurality of UPFs along the first data path which are enabled to detect congestion and perform congestion marking.

6. The method of claim 1, wherein said first communications path is one of an uplink communication path and a downlink communication path.

7. The method of claim 4, wherein the first network device receives the signal from the SMF indicating that congestion marking is to be supported at the first network device as part of Registration procedures.

8. The method of claim 4, wherein the first network device receives the signal from the SMF indicating that congestion marking is to be supported at the first network device as part of Protocol Data Unit (PDU) session procedures.

9. The method of claim 4, wherein said signal from the SMF instructs the first network device to perform both congestion information monitoring and congestion marking.

10. The method of claim 4, wherein said first network device is a UPF, the method further comprising:
receiving, at the first network device, a signal from the SMF indicating to the UPF to report congestion information of the QoS flow on uplink (UL) and downlink (DL) directions via GTP-U header extension to PSA UPF.

11. The method of claim 1, wherein said first network node is a PSA UPF, the method further comprising:
receiving reported congestion information of the QoS flow on UL and DL directions via GTP-U header extension from one or more to UPFs; and
using the received reported congestion information to perform Explicit Congestion Notification (ECN) bits marking for L4S for the corresponding direction.

12. A first network device in a communications network, the first network device comprising:
a data buffer;
a communications interface including a receiver and a transmitter;
a processor configured to control the first network device to:
detect congestion at a first network device including said data buffer, said first network device being in a first data path corresponding to a first communications session corresponding to a first UE device and an end point device, said data path including an access network (AN) node in addition to said first network device;
receive, at the first network device, a first data packet corresponding to the first communications session, said first data packet including a congestion indicator value set to a value indicating no congestion;
modify the congestion indicator value in the first data packet to indicate congestion; and
communicate the first data packet with the congestion indicator value set to indicate congestion to another device in the first data path.

13. The first network device of claim 12, wherein the first network device is a user plane function (UPF) device.

14. The first network device of claim 13, wherein the UPF device is a non-anchor UPF.

15. The first network of claim 14, wherein said processor is further configured to control the first network device to:
receive, at the first network device, a signal from a Session Management Function (SMF) indicating that congestion marking is to be supported at the first network device.

16. A method of operating a session management function (SMF), the method comprising:
operating the SMF to receive information relating to a first communications session; and
operating the SMF to enable one or more network devices to perform congestion marking with regard to the first communications session.

17. The method of claim 16, wherein operating the SMF to enable one or more network devices to perform congestion marking with regard to the first communications session includes:
sending, from the SMF, a first control signal to a first intermediate user plane function (UPF) in a data communications path used by the first communications session, to enable congestion marking of packets corresponding to the first communications session.

18. The method of claim 17,
wherein the first control signal enables marking by the first intermediate UPF in an uplink direction.

19. The method of claim 17,
wherein the first control signal enables marking by the first intermediate UPF in a downlink direction.

20. The method of claim 17,
wherein said first control signal further controls
the first intermediate UPF to monitor for congestion at the first intermediate UPF and perform congestion marking based on congestion detected at the first intermediate UPF.

21. The method of claim 17, further comprising:
operating the SMF to disable congestion marking with regard to the first communications session at the first intermediate UPF while the communications session is ongoing.

22. The method of claim 17, further comprising
sending a reporting control signal from the SMF, to the first intermediate UPF, to control the intermediate to report congestion information of a QoS flow on UL and DL directions via GTP-U header extension to PSA UPF.

23. The method of claim 17, wherein operating the SMF to enable one or more network devices to perform congestion marking with regard to the first communications session includes:
sending, from the SMF, a second control signal to a second intermediate UPF in a data communications path used by the first communications session, to enable congestion marking of packets corresponding to the first communications session at the second intermediate UPF.

24. A session management function (SMF) device, comprising:
memory;
a communications interface including a receiver and a transmitter; and
a processor configured to control the SMF to:
receive information relating to a first communications session; and
enable one or more network devices to perform congestion marking with regard to the first communications session.

25. The SMF device of claim 24, wherein said processor is configured to control the SMF to:
send, from the SMF, a first control signal to a first intermediate user plane function (UPF) in a data communications path used by the first communications session, to enable congestion marking of packets corresponding to the first communications session, as part of being configured to control the SMF to enable one or more network devices to perform congestion marking with regard to the first communications session.

26. The SMF device of claim 25,
wherein the first control signal enables marking by the first intermediate UPF in an uplink direction.

27. The SMF device of claim 25,
wherein the first control signal enables marking by the first intermediate UPF in a downlink direction.

28. The SMF device of claim 25,
wherein said first control signal further controls the first intermediate UPF to monitor for congestion at the first intermediate UPF and perform congestion marking based on congestion detected at the first intermediate UPF.

29. The SMF device of claim 25, wherein said processor is further configured to control the SMF device to:
operate the SMF to disable congestion marking with regard to the first communications session at the first intermediate UPF while the communications session is ongoing.

30. The SMF device of claim 25, wherein said processor is further configured to control the SMF device to:
send a reporting control signal from the SMF, to the first intermediate UPF, to control the intermediate to report congestion information of a QoS flow on UL and DL directions via GTP-U header extension to PSA UPF.
